(19) United States
(12) Patent Application Publication
(10) Pub. No.: US 2025/0154304 A1
(43) Pub. Date: May 15, 2025

(54) POLYMERIC STABILIZERS BASED ON METHOXY-HYDROXY BENZOIC ACIDS, PLASTIC COMPOSITION, METHOD FOR STABILIZING A PLASTIC COMPOSITION, AND STABILIZER COMPOSITION

(71) Applicant: FRAUNHOFER-GESELLSCHAFT ZUR FÖRDERUNG DER ANGEWANDTEN FORSCHUNG E.V., München (DE)

(72) Inventor: Rudolf PFAENDNER, Darmstadt (DE)

(73) Assignee: FRAUNHOFER-GESELLSCHAFT ZUR FÖRDERUNG DER ANGEWANDTEN FORSCHUNG E.V., München (DE)

(21) Appl. No.: 18/839,164

(22) PCT Filed: Feb. 3, 2023
(86) PCT No.: PCT/EP2023/052682

§ 371 Date: Aug. 16, 2024

(30) Foreign Application Priority Data
Feb. 16, 2022 (DE) 10 2022 201 632.7

(51) Int. Cl. C08F 218/10; C08L 23/06

(52) U.S. Cl. CPC C08F 218/10; C08L 23/06; C08L 2201/08; C08L 2207/066

(57) ABSTRACT

The present invention relates to polymeric stabilizers based on renewable raw materials from the group of methoxy-hydroxy benzoic acids, such as, for example, syringic acid, vanillic acid, isovanillic acid or 5-hydroxyveratric acid, to a plastic composition, to a method for stabilizing a plastic composition and to a stabilizer composition having a high stabilizing effect.

The present invention relates to polymeric stabilizers based on renewable raw materials, such as syringic acid, vanillic acid, isovanillic acid or 5-hydroxyveratric acid, to a plastic composition, to a method for stabilizing a plastic composition and to a stabilizer composition with a high stabilizing effect.

Organic materials such as plastics are subject to aging processes that ultimately lead to a loss of the desired properties, such as the mechanical characteristic values. This process, called autoxidation, leads to changes in the polymer chain, such as in the molecular weight and/or to the formation of new chemical groups, starting from radical chain cleavages by mechanochemical processes or by UV radiation in the presence of oxygen. Stabilizers are therefore used to prevent or at least delay this aging. Important representatives of stabilizers are antioxidants that interfere with the radicals formed during autoxidation and thus interrupt the degradation process. A distinction is generally made between primary antioxidants, which can react directly with oxygen-containing free radicals or C radicals, and secondary antioxidants, which react with intermediately formed hydroperoxides (see C. Kröhnke et al. Antioxidants in Ullmann's encyclopedia of industrial chemistry, Wiley-VCH Verlag, Weinheim 2015,). Typical representatives of primary antioxidants are, for example, phenolic antioxidants, amines, but also lactones. Classes of secondary antioxidants are phosphorus compounds such as phosphites and phosphonites, but also organo-sulfur compounds such as thioesters, thioethers and disulfides. Typically, primary and secondary antioxidants are often combined in practice, resulting in a synergistic effect.

Increasingly, plastics made from fossil raw materials such as crude oil or natural gas are being supplemented or replaced by plastics based on renewable raw materials using biotechnological processes. The question of sustainability then also arises for the primary and secondary antioxidants used for this purpose (and for plastics made from fossil raw materials). There is therefore a need for stabilizers based on renewable and available raw materials with high efficacy, low volatility and compatibility with polymer substrates. Ideally, the antioxidants also have a protective effect against photo-oxidation to protect polymers in outdoor applications.

### PRIOR ART

In principle, antioxidants from renewable raw materials are known, which are also occasionally used in plastics. Tocopherols (vitamin E) are a typical example. Like conventional antioxidants, tocopherols have a sterically hindered phenolic structure and can be used alone or in combination with secondary antioxidants (e.g. S. Al-Malaika, Macromol. Symp. 2001, 176, 107). Tocopherols are isolated from natural substances, such as wheat germ oil, sunflower oil or olive oil. Other known phenolic antioxidants from natural substances that have been investigated in plastics are described, for example, in the following literature references:
Quercetin (B. Kirschweng et al., Melt stabilization of PE with natural antioxidants: Comparison of rutin and quercetin, Eur. Pol. J. 2018, 103, 228-237), dihydromyricetin (B. Kirschweng et al, Melt stabilization of polyethylene with dihydromyricetin, a natural antioxidant, Pol. Degr. Stab. 2016, 133, 192-200),
Derivatives of rosmarinic acid (K. Doudin et al, New genre of antioxidants from renewable natural resources: Synthesis and characterization of rosemary plant-derived antioxidants and their performance in polyolefins, Pol. Degr. Stab. 2016, 130, 126-134),
Tannin (W. J. Grigsby et al, Esterification of condensed tannins and their impact on the properties of poly (lactic acid), Polymers 5 (2013) 344-360),
Curcumin (D. Tatraaljai et al. Processing stabilization of PE with a natural antioxidant, curcumin, European Polymer Journal 49 (2013) 1196-1203),
Silymarin and Sylibin (B. Kirschweng et al., Melt stabilization of polyethylene with natural antioxidants: comparison of a natural extract and its main components, Journal of Thermal Analysis and Calorimetry https://doi.org/10.1007/s10973-020-09709-5),
Catechin from tea and coffee extracts (O. Olejnik, A. Masek, Bio-Based Packaging Materials Containing Substances Derived from Coffee and Tea Plants, Materials 2020, 13, 5719).

Furthermore, the own applications for the stabilization of plastics with long-chain esters of ferulic acid (WO 2021/191078 A1) and ferulic acid salts (WO 2021/191364 A1) should be mentioned.

WO 98/18830 discloses polymeric stabilizers which simultaneously act as compatibilizers and describe, among other things, sterically hindered phenols, sterically hindered amines, lactones, phosphites with polymers including acrylic acid, glycidyl methacrylate, maleic anhydride and vinyl alcohol by polymer analogous reaction.

M. Rostagno et al. describe in “Sustainable polyvinyl acetals from bioaromatic aldehydes”, Polym. Chem. 2017, 8, 5049-5059, Polyacetals obtained from aldehydes. The structures are complex to synthesize, the resulting compounds are sensitive to hydrolysis, and their use as stabilizers has not been described.

CN 110183912 describes a floor coating that contains, among other things, 3,5-dimethoxy-4-hydroxycinnamic acid as a reaction component and, among other things, polyvinyl alcohol. The phenol group reacts and is therefore no longer available for antioxidant properties; there are no indications of antioxidant properties.

WO 2014/194055 describes polyesters, e.g. of ferulic acid with (poly)ethylene glycol, which are used in a hydrogel that can contain polyvinyl alcohol, among other things.

G. Jialanella, I. Piirma, “Synthesis of (polyvinyl alcohol-co-vinyl gallate) by the chemical modification of poly(vinyl alcohol)” describes the synthesis of the title polymer. Its use is described as an aqueous solution and complex formation; the publication does not mention its use in polymers for their stabilization.

What most of the stabilizers from renewable raw materials mentioned have in common, however, is that they have a comparatively high volatility or migration tendency. As an example, it has been shown that even comparatively high molecular weight natural antioxidants have a high migration potential (A. Masek, M. LatosBrozio, The Effect of Substances of Plant Origin on the Thermal and Thermo-Oxidative Ageing of Aliphatic Polyesters (PLA, PHA), Polymers 2018, 10, 1252).

The object of the present invention is therefore to provide effective antioxidants for plastics made from renewable raw materials, which at the same time have a very low volatility and/or low migration tendency.

### DISCLOSURE OF THE INVENTION

This object is achieved by polymers according to claim 1, the use of polymers for stabilizing plastics according to claim 9, in particular against oxidative, thermal and/or actinic degradation. In addition, the present invention relates to a plastic composition comprising the designated polymers as stabilizers. The present invention further relates to a method for stabilizing a plastic composition using the polymers according to the invention. Lastly, the present invention relates to a stabilizer composition consisting of the polymers according to the invention and at least one additive.

According to a first aspect, the present invention relates to a polymer containing a repeating unit (A) of general formula I

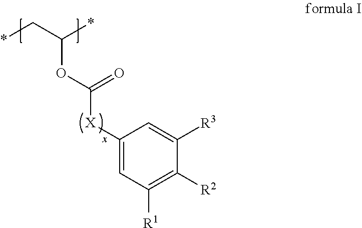

wherein
R¹, R² and R³ are each independently selected from the group consisting of hydroxy, linear or branched alkoxyl groups having 1 to 6 carbon atoms and hydrogen, with the proviso that at least one of the groups R¹, R² and R³ is a hydroxy group and at least one of the groups R¹, R² and R³ is a linear or branched alkoxy group having 1 to 6 carbon atoms, wherein R¹, R² and R³ are the same or different at each occurrence,
X is selected from the group consisting of —(CH₂)_{y}—, wherein y is an integer from 1 to 12, —(CH═CH)— and —(CH═CMe)-,
x is 0 or 1.

The polymer may contain the repeating unit (A) according to formula I. This means that, in addition to the repeating unit (A) according to formula I, there may be other repeating units that differ from the repeating unit (A) according to formula I. In this case, the polymer according to the invention is a copolymer. In the event that the repeating unit (A) according to formula I is the only repeating unit, the polymer according to the invention is a homopolymer. The copolymers can be present here as random, gradient, alternating or block copolymers.

Surprisingly, it was found that the polymers according to the invention not only have an excellent stabilizing effect on plastic materials, but also that the polymers according to the invention have a very low volatility and can be produced primarily on the basis of renewable raw materials.

The problem underlying the invention was thus solved in particular by using ester derivatives of polyvinyl alcohol polymers or polyvinyl alcohol copolymers which contain alpha-methoxy-substituted phenols as active components. In principle, it is thus possible to produce stabilizers based entirely on renewable raw materials, since not only the alpha-methoxy-substituted phenols are accessible on a renewable basis, but also polyvinyl acetates and polyvinyl alcohol, such as described in M. Amann, O. Minge, Biodegradability of Poly(vinyl acetate) and Related Polymers, Adv. Polym. Sci. (2012) 245: 137-172.

According to a preferred embodiment
R¹ is hydrogen, hydroxy or a linear or branched alkoxyl group having 1 to 6 carbon atoms, in particular methoxy,
R² is hydroxy and
R³ is a linear or branched alkoxyl group having 1 to 6 carbon atoms, in particular methoxy.

The ester groups of the repeating unit of general formula I are derived in particular from naturally occurring compounds such as

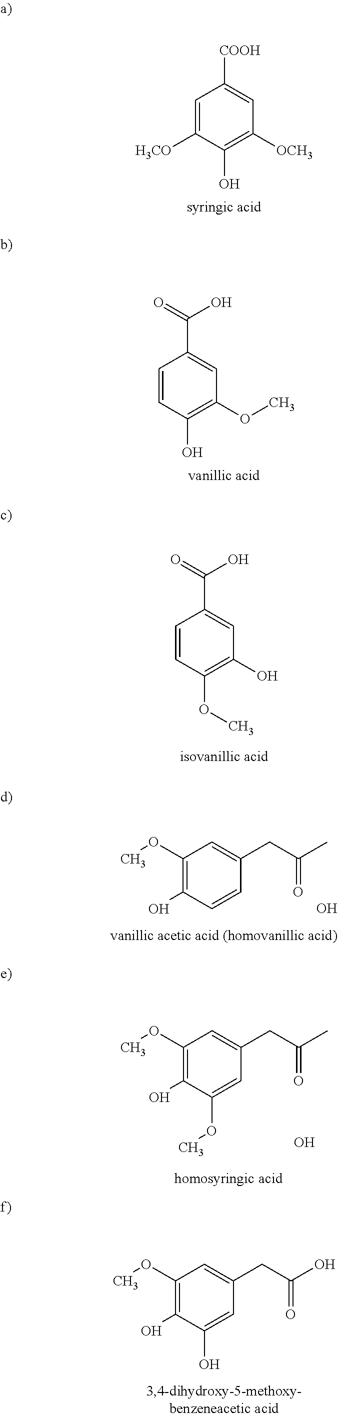

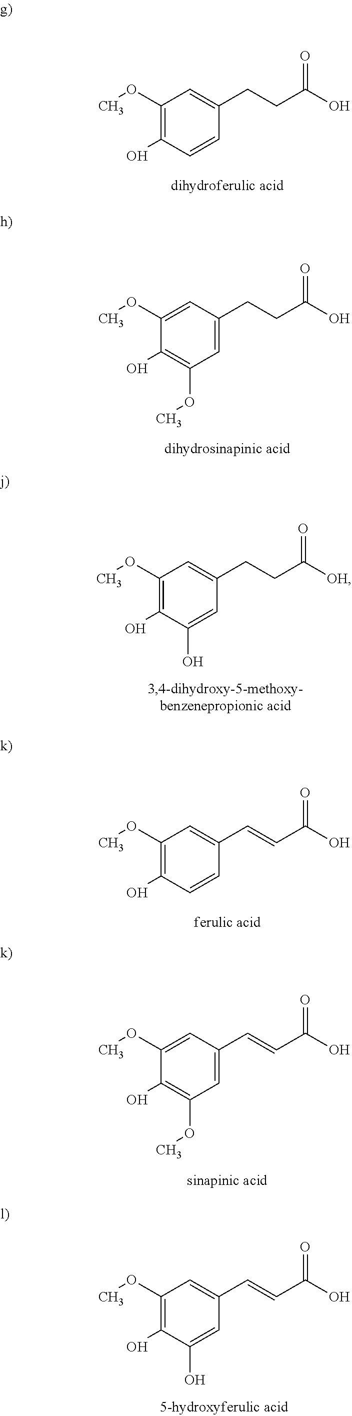

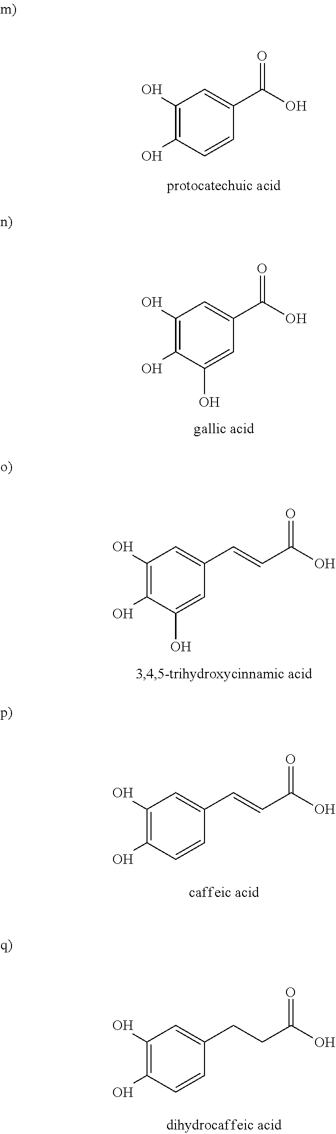

Surprisingly, the polymers according to the invention are characterized by a high stabilizing potential in the stabilization of plastics, in particular against oxidative, thermal and/or actinic degradation, and can be produced in a manner known per se from the prior art.

The acids used above as starting products, such as syringic acid, vanillic acid, isovanillic acid or 5-hydroxyveratric acid, are commercially available.

The acids or acid derivatives used as starting products, such as the methyl esters, are commercially available or accessible via known methods, e.g. via basic or acid-catalyzed esterification with alcohols.

The vinyl alcohol esters can be prepared, for example, by reaction with the acids in the form of a polymer-analogous reaction under acid catalysis, e.g. in the presence of sulfuric acid or p-toluenesulfonic acid in a suitable solvent or suspending agent such as toluene, with removal of the resulting water, e.g. by distillation.

Another possibility is a process in which first a short-chain ester, such as the methyl ester or the ethyl ester of the respective acid, is produced and in a second stage a transesterification reaction with the polyvinyl alcohol takes place in the presence of a suitable catalyst, such as dibutyltin butoxide, dioctyltin diacetate, dioctyltin ketonate or tetrabutyl titanate, tetraisobutyl titanate, tetrapropyl orthotitanate. Alternatively, the esterification and/or transesterification reaction can also be carried out enzymatically, e.g. as described in K. Vosrmann et al. Appl. Microbiol. Biotechnol. (2008) 80:29-36. Another possibility is the transesterification of polyvinyl acetate using the respective acid with the removal of acetic acid. If necessary, the phenol group can also be provided with a protective function in a first synthesis step, which is removed again after esterification. One possible protective group is the triethylsilyl group, for example, which can be introduced using triethylsilane.

The polymer according to the invention can, for example, be constructed exclusively of identical repeating units (A). It is also possible for the polymer to be composed exclusively of repeating units (A), but in this case at least two repeating units (A) which are different from one another and can be subsumed under formula I (e.g. due to a different substitution pattern of the groups R¹ to R³) are present.

In accordance with a further preferred embodiment, the polymer is formed as a copolymer and thus contains at least one further repeating unit (B), selected from repeating units derived from monomers polymerizable by free-radical, controlled free-radical or coordinative polymerization. The at least one further repeating unit (B) thus differs from the repeating units (A) according to formula I.

For example, it may be that the at least one further repeating unit (B) is selected from the following repeating units:

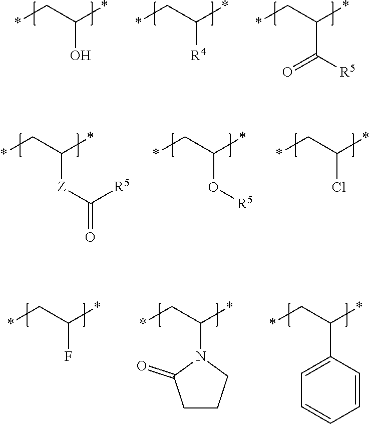

wherein
R⁴ is selected from the group consisting of hydrogen and linear or branched alkyl radicals having 1 to 36 carbon atoms,
R⁵ is selected from the group consisting of linear or branched alkyl radicals having 1 to 36 carbon atoms, and
Z is O or NH.

In the aforementioned case, the molar ratio of the repeating unit (A) to the total of all repeating units is preferably 0.01 to <1.0, preferably 0.25 to 0.95, particularly preferably 0.40 to 0.90.

The polymer according to the invention preferably has a weight-average molecular weight of 10³ to 10⁶ g/mol, preferably 5·10³ to 5·10⁵ g/mol, particularly preferably 7.5·10³ to 10⁵ g/mol.

Very particularly preferably, the polymer according to the invention contains or consists of the repeating unit (A) according to general formula I and the subsequent repeating units (B1) and (B2):

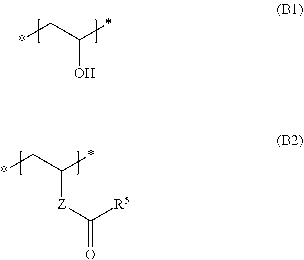

wherein Z and R⁵ have the meaning given above, in particular Z is oxygen and R⁵ is ethyl.

Preferably, in the polymer according to the invention,
the molar ratio of the repeating unit (A) to the total of all repeating units is 0.25 to 0.95, particularly preferably 0.40 to 0.90,
the molar ratio of the repeating unit (B1) to the total of all repeating units is 0.05 to 0.50, preferably 0.20 to 0.32,
the molar ratio of the repeating unit (B2) to the total of all repeating units is 0.05 to 0.25, preferably 0.08 to 0.20.

The synthesis of copolyesters with gallate is described in G. Jialanella, I. Piirma, Synthesis of (polyvinyl alcohol-co-vinyl gallate) by the chemical modification of poly(vinyl alcohol). The synthesis of ethylene-vinyl ester copolymers, for example, can be carried out analogously to K. Henning et al, Polymeranaloge Umsetzungen an Ethylen-Vinylalkohol-Copolymeren, Acta Polymerica, 1990, 41, 285-289.

The following copolymers, for example, are particularly preferred:
polyvinyl ester-co-polyvinyl acetate
polyvinyl ester-co-polyvinyl acetate-co-polyvinyl alcohol
polyvinylester-co-polyethylene
polyvinyl ester-co-polyethylene-co-polyvinyl alcohol
polyvinyl ester-co-polydodecylene
polyvinyl ester-co-polydodecylene-co-polyvinyl alcohol
polyvinyl ester-co-polyoctadecylene
polyvinyl ester-co-polyoctadecylene-co-polyvinyl alcohol
polyvinyl ester-co-1-ethylene oxydodecane
polyvinyl ester-co-1-ethylene oxydodecane-co-polyvinyl alcohol
polyvinyl ester-co-(meth)acrylates, such as polyvinyl ester-co-n-butyl acrylate, polyvinyl
ester-co-polylauryl acrylate
polyvinyl ester-co-polymethyl methacrylate
polyvinyl ester-co-polyethylene-co-polyvinyl chloride
polyvinyl ester-co-polyethylene-co-polyvinyl chloride-co-polyvinyl alcohol
polyvinylester-co-polystyrene
polyvinyl ester-co-polystyrene-co-polyvinyl alcohol
polyvinyl ester-co-polystyrene-co-polyethylene
polyvinyl ester-co-polyvinylpyrrolidone
polyvinyl ester-co-fluoroethylene
polyvinyl ester-co-polyacrylamide

Preferred are copolyvinyl esters with polyvinyl acetate, polyvinyl alcohol and with polyethylene.

The polyvinyl alcohol copolymers required for the production of the polymers according to the invention are commercially available. The polyvinyl alcohol content can be adjusted by proportionally saponifying polyvinyl acetate. The content of polyvinyl alcohol or polyvinyl acetate is part of the specifications for commercially available products.

The present invention additionally relates to the use of a polymer or a mixture of several polymers containing a repeating unit (A) of general formula I

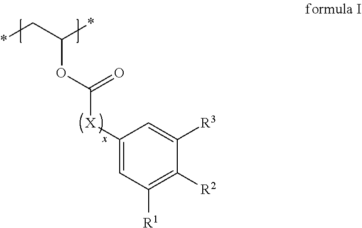

wherein
R¹, R² and R³ are each independently selected from the group consisting of hydroxy, linear or branched alkoxyl groups having 1 to 6 carbon atoms and hydrogen, with the proviso that at least one of groups R¹, R² and R³ is a hydroxy group, wherein R¹, R² and R³ are the same or different at each occurrence,
X is selected from the group consisting of —(CH₂)_{y}—, wherein y is an integer from 1 to 12, —(CH═CH)— and —(CH═CMe)-,
x is 0 or 1,
for stabilizing plastics, in particular against oxidative, thermal and/or actinic degradation.

It is preferred here that at least one of the groups R¹, R² and R³ is a linear or branched alkoxy group having 1 to 6 carbon atoms. Thus, the polymers described above are used according to the invention. All other preferred embodiments of the polymers according to the invention also apply without restriction to the use according to the invention.

It is preferred here if the polymer or the mixture of several polymers is contained in the plastic in a proportion by weight from 0.01 to 10.00 wt. %, preferably from 0.02 to 5.00 wt. %, particularly preferably from 0.05 to 2.00 wt. %.

The plastics to be stabilized are, for example, thermoplastic, thermoset or elastomeric polymers.

In particular, the polymers according to general formula I are suitable for stabilizing plastics, wherein the plastic is selected from the group consisting of
a) polymers of olefins or diolefins, such as polyethylene (LDPE, LLDPE, VLDPE, ULDPE, MDPE, HDPE, UHMWPE), metallocene-PE (m-PE), polypropylene, polyisobutylene, poly-4-methyl-pentene-1, polybutadiene, polyisoprene, such as natural rubber (NR), polycyclooctene, polyalkylene-carbon monoxide copolymers, as well as copolymers in the form of random or block structures, such as polypropylene-polyethylene (EP), EPM or EPDM with. for example, 5-ethylidene-2-norbornene as comonomer, ethylene-vinyl acetate (EVA), ethylene acrylic ester, such as ethylene-butyl acrylate, ethylene-acrylic acid and their salts (ionomers), as well as terpolymers such as ethylene-acrylic acid-glycidyl (meth)acrylate, graft polymers such as polypropylene-graft-maleic anhydride, polypropylene-graft-acrylic acid, polyethylene-graft-acrylic acid, polyethylene-polybutyl acrylate-graft-maleic anhydride as well as blends such as LDPE/LLDPE or also long-chain branched polypropylene copolymers produced with alpha-olefins as comonomers, for example with 1-butene, 1-hexene, 1-octene or 1-octadecene,
b) polystyrene, polymethylstyrene, poly-alpha-methylstyrene, polyvinylnaphthalene, polyvinylbiphenyl, polyvinyltoluene, styrene-butadiene (SB), styrene-butadiene-styrene (SBS), styrene-ethylene-butylene-styrene (SEBS), styrene-ethylene-propylene-styrene, styrene isoprene, styrene-isoprene-styrene (SIS), styrene-butadiene-acrylonitrile (ABS), styrene-acrylonitrile (SAN), styrene-acrylonitrile-acrylate (ASA), methacrylate-butadiene-styrene (MBS), styrene-ethylene, styrene-maleic anhydride polymers including corresponding graft copolymers such as styrene on butadiene, maleic anhydride on SBS or SEBS, as well as graft copolymers of methyl methacrylate, styrene butadiene and ABS (MABS), as well as hydrogenated polystyrene derivatives such as polyvinylcyclohexane,
c) halogen-containing polymers such as polyvinyl chloride (PVC), polychloroprene and polyvinylidene chloride (PVDC), copolymers of vinyl chloride and vinylidene chloride or of vinyl chloride and vinyl acetate, chlorinated polyethylene, polyvinylidene fluoride, epichlorohydrin—homo and copolymers in particular with ethylene oxide (ECO),
d) polymers of unsaturated esters such as polyacrylates and polymethacrylates such as polymethyl methacrylate (PMMA), polybutyl acrylate, polylauryl acrylate; polystearyl acrylate; polyglycidyl acrylate, polyglycidyl methacrylate, polyacrylonitrile, polyacrylamides, copolymers such as polyacrylonitrile-polyalkyl acrylate,
e) polymers of unsaturated alcohols and derivatives, such as polyvinyl alcohol, polyvinyl acetate, polyvinyl butyral, polyallyl phthalate, polyallyl melamine,
f) polyacetals, such as polyoxymethylene (POM) or copolymers with, for example, butanal,
g) polyphenylene oxides and blends with polystyrene or polyamides,
h) polymers of cyclic ethers, such as polyethylene glycol, polypropylene glycol, polyethylene oxide, polypropylene oxide, polytetrahydrofuran,
i) polyurethanes, from hydroxy-terminated polyethers or polyesters and aromatic or aliphatic isocyanates, such as 2,4- or 2,6 toluene diisocyanate or methylene diphenyl diisocyanate, in particular also linear polyurethanes (TPU), polyureas,
j) polyamides such as polyamide-6, 6.6, 6.10, 4.6, 4.10, 6.12, 10.10, 10.12, 12.12, polyamide 11, polyamide 12 and (partially) aromatic polyamides such as polyphthalamides, e.g. produced from terephthalic acid and/or isophthalic acid and aliphatic diamines such as hexamethylenediamine or m-xylylenediamine or from aliphatic dicarboxylic acids such as adipic acid or sebacic acid and aromatic diamines such as hexamethylenediamine or m-xylylenediamine or from aliphatic dicarboxylic acids such as adipic acid or sebacic acid and aromatic diamines such as 1,4- or 1,3-diaminobenzene, blends of different polyamides such as PA-6 and PA 6.6 or blends of polyamides and polyolefins such as PA/PP,
k) polyimides, polyamideimides, polyetherimides, polyesterimides, poly(ether)ketones, polysulfones, polyethersulfones, polyarylsulfones, polyphenylene sulfides, polybenzimidazoles, polyhydantoins,
l) polyesters of aliphatic or aromatic dicarboxylic acids and diols or of hydroxy-carboxylic acids, such as polyethylene terephthalate (PET), polybutylene terephthalate (PBT), polypropylene terephthalate (PTI), polyethylene naphthylate (PEN), poly-1,4-dimethylolcyclohexane terephthalate, polyhydroxybenzoate, polyhydroxynaphthalate, polylactic acid (PLA), polyhydroxybutyrate (PHB), polyhydroxyvalerate (PHV), polyethylene succinate, polytetramethylene succinate, polycaprolactone,
m) polycarbonates, polyester carbonates, as well as blends such as PC/ABS, PC/PBT, PC/PET/PBT, PC/PA,
n) cellulose derivatives such as cellulose nitrate, cellulose acetate, cellulose propionate, cellulose butyrate,
o) epoxy resins consisting of di- or polyfunctional epoxy compounds in combination with, for example, hardeners based on amines, anhydrides, dicyandiamide, mercaptans, isocyanates or catalytically acting hardeners,
p) phenolic resins such as phenol-formaldehyde resins, urea-formaldehyde resins, melamine-formaldehyde resins,
q) unsaturated polyester resins from unsaturated dicarboxylic acids and diols with vinyl compounds, for example styrene, alkyd resins, alkyd resins,
r) silicones, for example based on dimethylsiloxanes, methyl-phenyl-siloxanes or diphenylsiloxanes, for example vinyl-group-terminated,
s) as well as mixtures, combinations or blends of two or more of the aforementioned polymers.

If the polymers specified under a) to r) are copolymers, they can be in the form of random, block or tapered structures. Furthermore, the mentioned polymers can be present in the form of linear, branched, star-shaped or hyper-branched structures.

If the polymers specified under a) to r) are stereoregular polymers, they can be in the form of isotactic, stereotactic, but also atactic forms or as stereoblock copolymers.

If necessary, the polyolefins mentioned under a) can also be cross-linked, for example cross-linked polyethylene, which is then called X-PE.

Furthermore, the present compounds can be used to stabilize rubbers and elastomers. These can be natural rubber (NR) or synthetic rubber materials.

Suitable synthetic rubber materials consist in particular of butadiene (BR), styrene-butadiene (SBR), chloroprene (CR), isoprene (IR), isobutylene-isors, acrylonitrile-butadiene (NBR or in hydrogenated form HNBR). Other suitable rubbers and elastomers are ethylene-propylene-diene terpolymers (EPDM) and ethylene-propylene copolymers (EPM), polyester urethanes (AU), polyether urethanes (EU) and silicones (MQ).

In addition to virgin material, the plastics can be recycled plastics, e.g. from industrial collections such as production waste or plastics from household or recyclable material collections.

Particularly preferred polymers are thermoplastic halogen-free polymers, in particular polyolefins based on the aforementioned polyethylenes or polypropylenes.

Polymers made from renewable raw materials, in particular aliphatic polyesters made from renewable raw materials such as polylactic acid (PLA), polyhydroxybutyric acid (PHB), polyhydroxyvaleric acid (PHV), polybutylene succinate (PBS), polybutylene succinate-co-adipate (PBSA), polyethylene succinate, polypropylene succinate, are also preferred.

Furthermore, the polymers specified under a) to r) can have both amorphous and (partially) crystalline morphologies.

In accordance with a further preferred embodiment, at least one further additive selected from the group consisting of primary antioxidants, secondary antioxidants, UV absorbers, light stabilizers, in particular the hindered amines as light (HALS) and long-term heat stabilizers (HAS), metal deactivators, filler deactivators, antiozonants, nucleating agents, antinucleating agents, transparency improvers (clarifiers), impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde and formaldehyde scavengers, blowing agents, degradation additives (prodegradants), defoaming agents, odour scavengers, odour-improving substances, PVC heat stabilizers, marking agents, antifogging agents, gloss improvers, mattifying agents, additives for increasing the electrical and/or thermal conductivity, repellents, fillers and reinforcing agents and mixtures thereof is contained or added.

Preferably, the compositions contain or use secondary antioxidants, in particular phosphites/phosphonites, sulfites, acid scavengers, costabilizers based on polyols and/or light stabilizers from the group of hindered amines (HALS).

Primary antioxidants act as H-donors and as radical scavengers and thus interrupt the radical autoxidation process in polymers. Suitable primary antioxidants are phenolic antioxidants, (semi-)aromatic amines, hydroxylamines and lactones.

Suitable synthetic phenolic antioxidants are, for example:
alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear or branched nonylphenole, such as 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, and mixtures thereof;
alkylthiomethylphenols, such as 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol;
hydroquinones and alkylated hydroquinones, such as 2,6-di-tert-butyl-4-methyoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenylstearate, bis(3,5-di-tert-butyl-4-hydroxylphenyl)adipate;
tocopherols, such as α-, β-, γ-, δ-tocopherol and mixtures of these (vitamin E);
hydroxylated thiodiphenyl ethers, such as 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide;
alkylidene bisphenols, such as 2,2′methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethyleneglycol-bis[3,3-bis(3′-tert-butyl-4′-hydroxyphenyl)butyrate], bis(3-tert-butyl-4-hydroxy-5-methylphenyl)dicyclo-pentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane;
O-, N- and S-benzyl compounds, such as 3,5,3′,5′-tetra-tert-butyl-4,4′-dihydroxydibenzylether, octadecyl-4-hydroxy-3,5-dimethylbenzylmercaptoacetate, tridecyl-4-hydroxy-3,5-di-tert-butyl-benzyl-mercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate;
hydroxybenzylated malonates, such as dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate;
aromatic hydroxybenzyl compounds, such as 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;
riazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroyphenylpropionyl)hexahydro-1,3,5-triazine, 1,3,5-tris(3,5-dicyclohexyl-4-hydroxybenzyl)isocyanurate;
benzyl phosphonates, such as. dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, octadecyl-5-tert-butyl-4-hydroxy-3-methylbenzylphosphonate, the calcium salt of the monoethyl ester of 3,5-di-tert-butyl-4-hydroxybenzylphosphonic acid; acylaminophenols, such as 4-hydroxylauranilide, 4-hydroxystearanilide, octyl N-(3,5-di-tert-butyl-4-hydroxyphenyl)carbamate;
esters of β-(3,5-di-tert-butyl-4-hydroxyphenyl)propionic acid with monohydric or polyhydric alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of β-(5-tert-butyl-4-hydroxy-3-methylphenyl)propionic acid with monohydric or polyhydric alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane, 3,9-bis[2-{3-(3-tert-butyl-4-hydroxy-5-methylphenyl)propionyloxy}-1,1-dimethylethyl]-2,4,8,10-tetraoxaspiro[5.5]undecane;
esters of β3-(3,5-dicyclohexyl-4-hydroxyphenyl)propionic acid with monovalent or polyvalent alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of (3,5-di-tert-butyl-4-hydroxyphenyl)acetic acid with monohydric or polyhydric alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
amides of β-(3,5-di-tert-butyl-4-hydroxyphenyl)propionic acid such as N,N′-bis(3,5-di-tert-butyl-4-hydroxyphenylpropionyl)hexamethylenediamide, N,N′-bis(3,5-di-tert-butyl-4-hydroxyphenylpropionyl) hexamethylenediamide, N,N′-bis(3,5-di-tert-butyl-4-hydroxyphenylpropionyl)hexamethylenediamide, N,N′-bis(3,5-di-tert-butyl-4-hydroxyphenylpropionyl)hydrazide, N,N′-bis[2-(3-[3,5-di-tert-butyl-4-hydroxy-phenyl]propionyloxy)ethyl]oxamide (Naugard®XL-1, distributed by Uniroyal);

### Vitamin C

Particularly preferred phenolic antioxidants are:

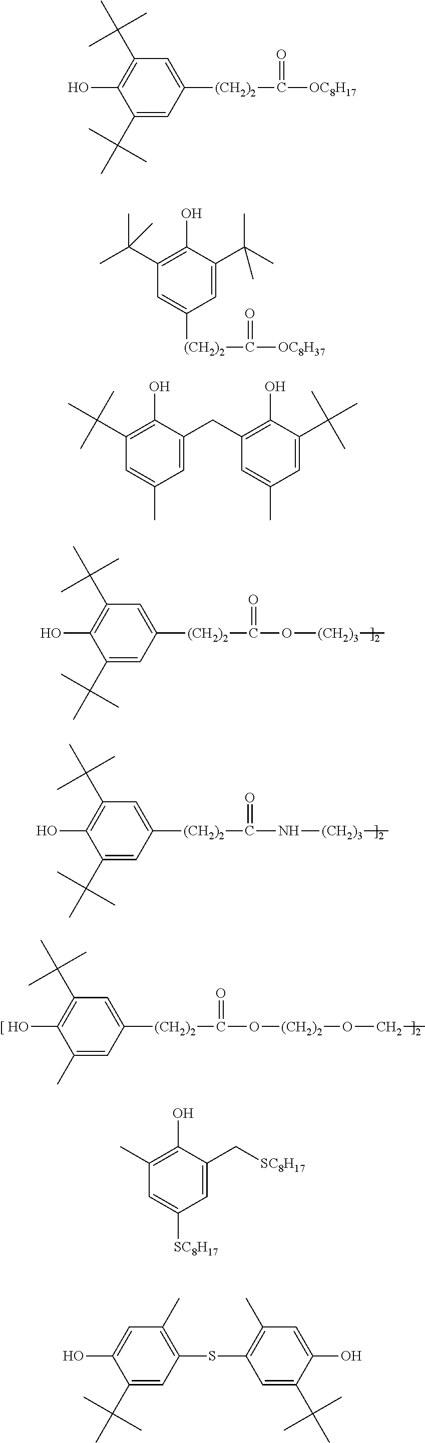

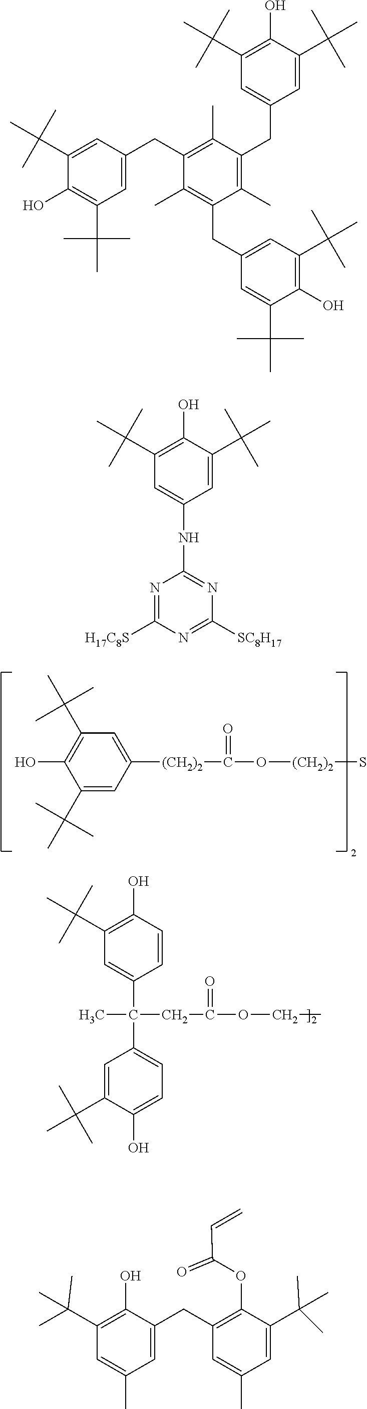

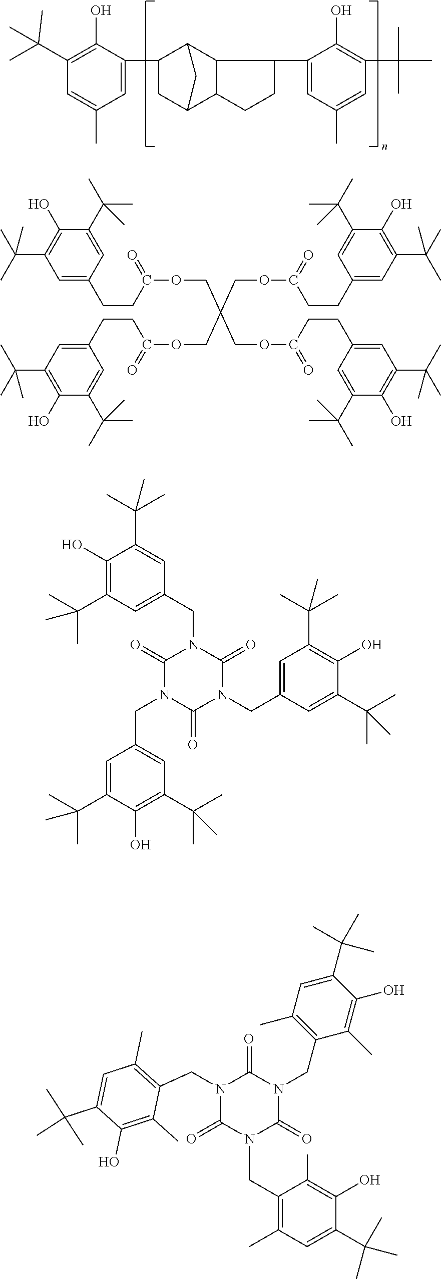

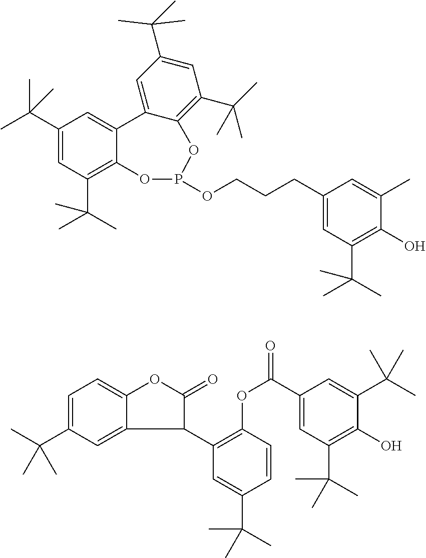 [SMILES: Cc1cc(CCCOp2oc3c(C(C)(C)C)cc(C(C)(C)C)cc3c3cc(C(C)(C)C)cc(C(C)(C)C)c3o2)cc(C(C)(C)C)c1O ; CC(C)(C)c1ccc(OC(=O)c2cc(C(C)(C)C)c(O)c(C(C)(C)C)c2)c(C2C(=O)Oc3ccc(C(C)(C)C)cc32)c1]

Further particularly preferred phenolic antioxidants are based on sustainable raw materials such as tocopherols (vitamin E), tocotrienols, tocomonoenols, carotenoids, hydroxytyrosol, flavonols such as chrysin, quercetin, hesperidin, neohesperidin, naringin, morin, camphor oil, fisetin, anthocyanins such as delphinidin and malvidin, curcumin, carnosic acid, carnosol, rosmarinic acid, resveratrol and tannins.

Suitable aminic antioxidants are, for example:

N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylamino-phenol, bis(4-methoxyphenyl)amine, 2,6-di-tert-butyl-4-dimethylaminomethyl-phenol, 2,4′-diaminodiphenylmethane, 4,4′-diaminodiphenylmethane, N,N,N′,N′-tetra-methyl-4,4′-diaminodiphenylmethane, 1,2-bis[(2-methyl-phenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, and mixtures or combinations thereof.

Preferred aminic antioxidants are: N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine.

Particularly preferred aminic antioxidants are the structures:

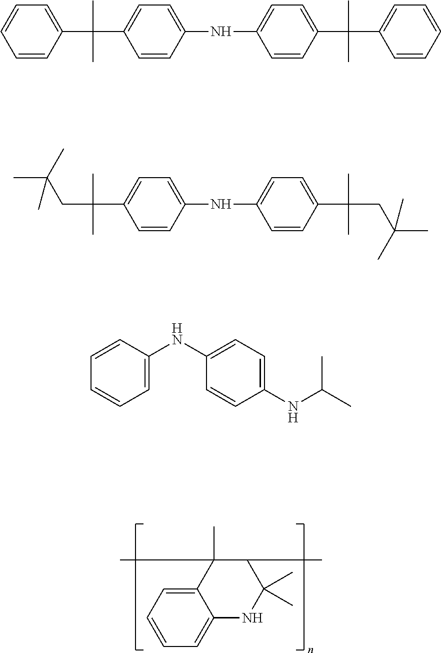

Preferred hydroxylamines or N-oxides (nitrones) are, for example, N,N-dialkylhydroxylamines, N,N-dibenzylhydroxylamine, N,N-dilaurylhydroxylamine, N,N-distearylhydroxylamine, N-benzyl-α-phenylnitrone, N-octadecyl-α-hexadecylnitrone, as well as Genox EP (SI Group) according to the formula:

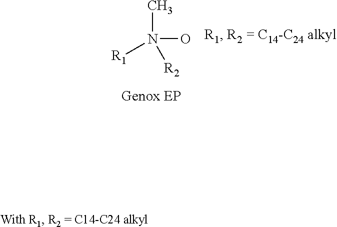

Suitable lactones are benzofuranones and indolinones are, for example, 3-(4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-(2-hydroxyethoxy]phenyl)benzofuran-2-one), 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2,3-dimethylphenyl)-5,7-di-tert-butyl-benzofuran-2-one as well as lactones that additionally contain phosphite groups such as

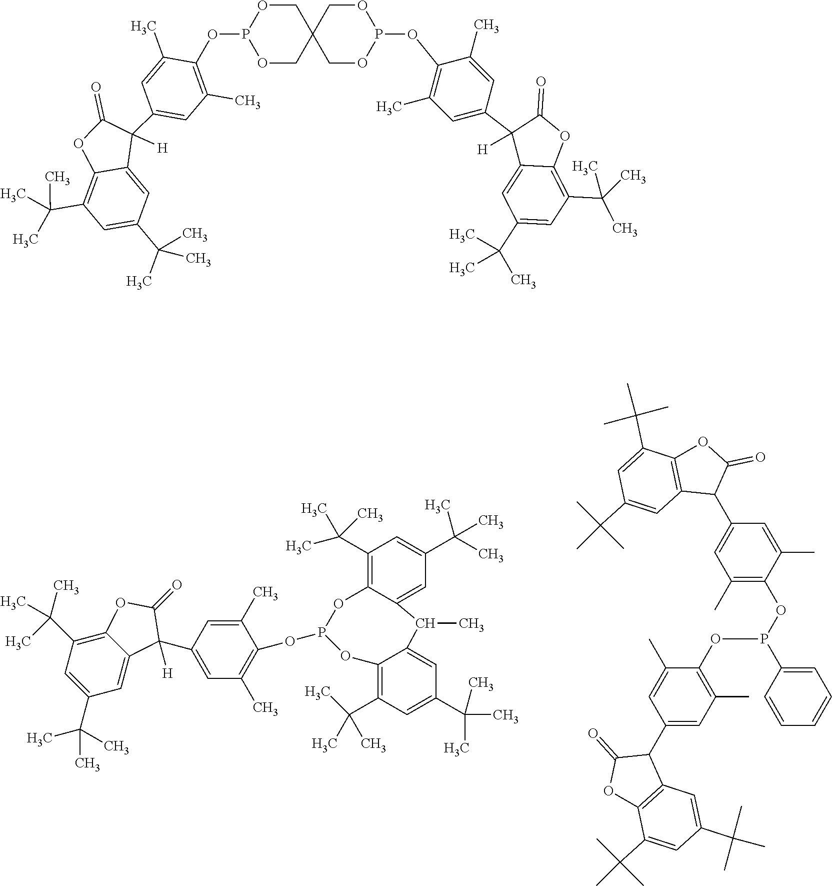

A particularly preferred lactone has the following structure:

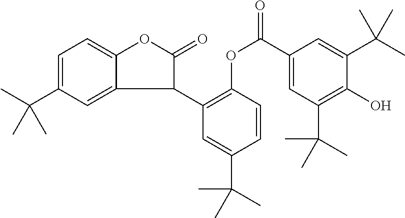 [SMILES: CC(C)(C)c1ccc(OC(=O)c2cc(C(C)(C)C)c(O)c(C(C)(C)C)c2)c(C2C(=O)Oc3ccc(C(C)(C)C)cc32)c1]

A further suitable group of antioxidants are isoindolol[2,1-A]quinazolines, such as

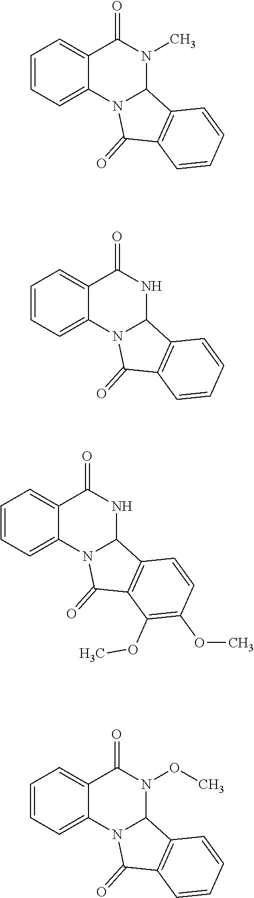 [SMILES: CN1C(=O)c2ccccc2N2C(=O)c3ccccc3C12 ; O=C1NC2c3ccccc3C(=O)N2c2ccccc21 ; COc1ccc2c(c1OC)C(=O)N1c3ccccc3C(=O)NC21 ; CON1C(=O)c2ccccc2N2C(=O)c3ccccc3C12]

Secondary antioxidants primarily act as hydroperoxide decomposers in the stabilization of plastics.

Suitable secondary antioxidants are in particular phosphites or phosphonites such as triphenylphosphite, diphenylalkylphosphites, phenyldialkylphosphites, tri(nonylphenyl)phosphite, trilaurylphosphites, trioctadecylphosphite, distearylpentaerythritol diphosphite, tris-(2,4-di-tert-butylphenyl)phosphite, diisodecylpentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl)-4,4′-biphenylenediphosphonite, 6-isooctyloxy-2,4,8,10-tetra-tert-butyl-12 H-dibenz[d,g]-1,3,2-dioxaphosphocine, bis(2,4-di-tert-butyl-6-methylphenyl)methylphosphite, bis(2,4-di-tert-butyl-6-methylphenyl)ethylphosphite, 6-fluoro-2,4,8,10-tetra-tert-butyl-12-methyl-dibenz[d,g]-1,3,2-dioxaphosphocine, 2,2′2″-nitrilo[triethyltris(3,3″,5,5′-tetra-tert-butyl-1, 1′-biphenyl-2,2′-diyl)phosphite], 2-ethylhexyl(3,3′,5,5′-tetra-tert-butyl-1, 1′-biphenyl-2,2′-diyl))phosphite, 5-butyl-5-ethyl-2-(2,4,6-tri-tert-butylphenoxy)-1,2-dioxaphosphirane.

Particularly preferred phosphites are:

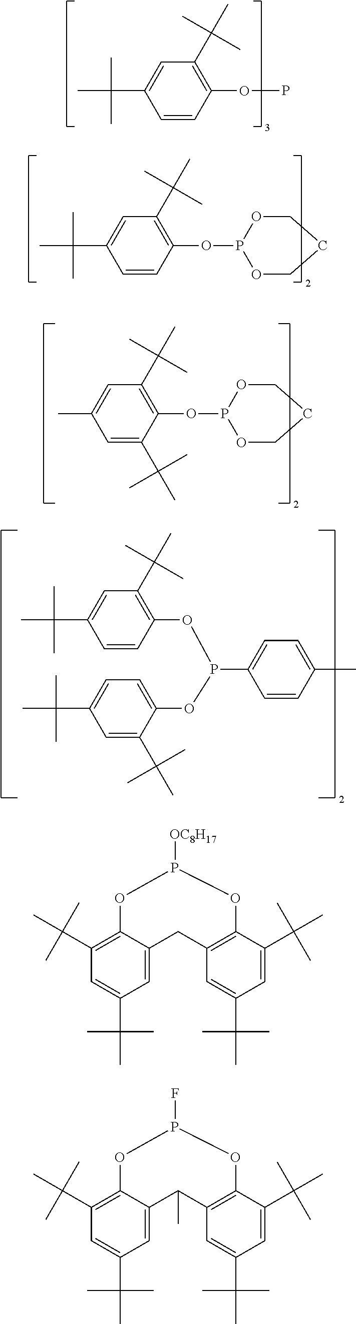

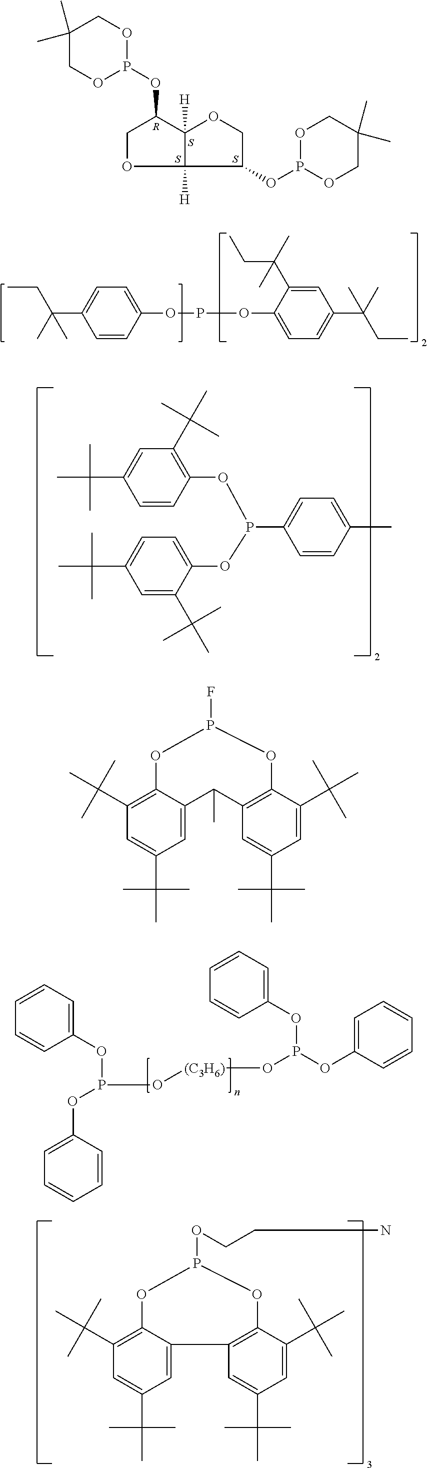

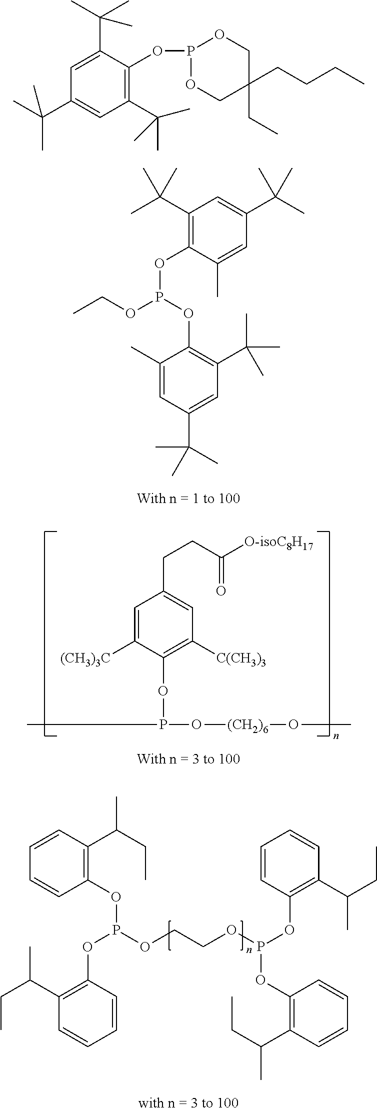

A preferred phosphonite is

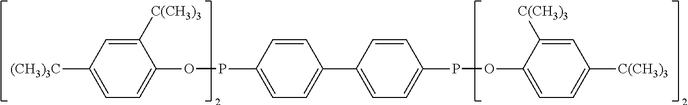

Suitable secondary antioxidants continue to be organo-sulfur compounds such as distearyl thiodipropionate, dilauryl thiodipropionate; ditridecyl dithiopropionate, ditetradecyl thiodipropionate, 3-(dodecylthio)-1,1′-[2,2-bis[[3-(dodecylthio)-1-oxopropoxy]methyl]-1,3-propanediyl]propanoic acid ester. The following structures are preferred:

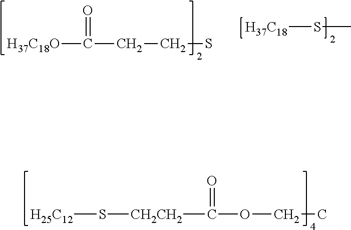

Other suitable secondary antioxidants are sulfites:

Inorganic sulfites, disulfites or thiosulfates of a monovalent, divalent, trivalent or tetravalent metal are preferred, the metal preferably being an alkali metal, an alkaline earth metal, aluminum and/or zinc, and the inorganic sulfite being used in particular in its form free of water of crystallization.

Suitable salts are in particular sodium sulfite, potassium sulfite, lithium sulfite, calcium sulfite, magnesium sulfite, aluminum sulfite or zinc sulfite. Thiosulfates such as sodium thiosulfate are also suitable.

Suitable fillers and reinforcing materials are, for example, synthetic or natural materials such as calcium carbonate, silicates, glass fibers, glass balls (solid or hollow), talc, mica, kaolin, barium sulfate, metal oxides and metal hydroxides, carbon black, graphite, carbon nanotubes, graphene, wood flour or fibers of natural products such as cellulose or synthetic fibers. Other suitable fillers are hydrotalcites or zeolites or layered silicates such as montmorillonite, bentonite, beidelite, mica, hectorite, saponite, vermiculite, ledikite, magadite, illite, kaolinite, wollastonite, and attapulgite.

Suitable acid scavengers (“antiacids”) are salts of monovalent, divalent, trivalent or tetravalent metals, preferably alkali metals, alkaline earth metals, aluminum or zinc, in particular formed with fatty acids, such as calcium stearate, magnesium stearate, zinc stearate, aluminum stearate, calcium laurate, calcium behenate, calcium lactate, calcium stearoyl-2-lactate. Other classes of suitable acid scavengers are hydrotalcites, in particular synthetic hydrotalcites based on aluminum, magnesium and zinc, hydrocalumites, zeolites, alkaline earth oxides, in particular calcium oxide and magnesium oxide as well as zinc oxide, alkaline earth carbonates, in particular calcium carbonate, magnesium carbonate and dolomite as well as hydroxides, in particular brucite (magnesium hydroxide).

Suitable costabilizers are also polyols, in particular alditols or cyclitols. Polyols are, for example, pentaerythritol, dipentaerythritol, tripentaerythritol, short-chain polyether polyols or polyester polyols, as well as hyperbranched polymers/oligomers or dendrimers with alcohol groups, for example

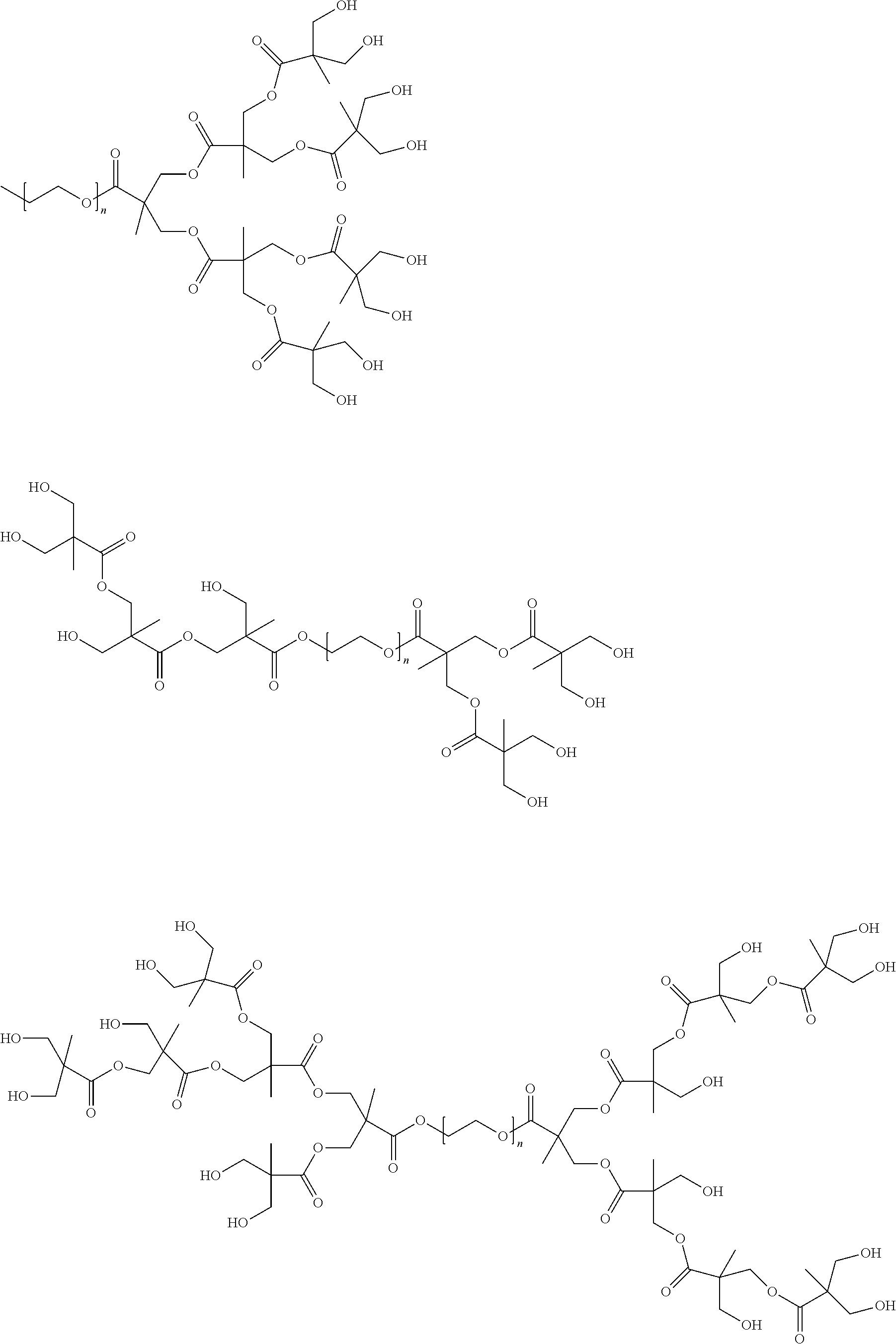

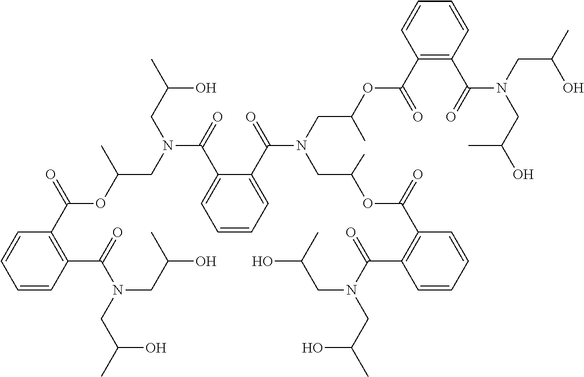 [SMILES: CC(O)CN(CC(C)O)C(=O)c1ccccc1C(=O)OC(C)CN(CC(C)O)C(=O)c1ccccc1C(=O)N(CC(C)OC(=O)c1ccccc1C(=O)N(CC(C)O)CC(C)O)CC(C)OC(=O)c1ccccc1C(=O)N(CC(C)O)CC(C)O]

Preferably, the at least one alditol is selected from the group consisting of threitol, erythritol, galactitol, mannitol, ribitol, sorbitol, xylitol, arabitol, isomaltol, lactitol, maltitol, altritol, iditol, maltotritol, and hydrogenated oligo- and polysaccharides having polyol end groups and mixtures thereof. Particularly preferred is the at least one preferred alditol selected from the group consisting of erythritol, mannitol, isomalt, maltitol and mixtures thereof.

Examples of other suitable sugar alcohols are heptitols and octitols: meso-glycero-allo heptitol, D-glycero-D-altro heptitol, D-glycero-D-manno heptitol, meso-glycero-gulo heptitol, D-glycero-D-galacto heptitol (perseitol), D-glycero-D-gluco heptitol, L-glycero-D-gluco heptitol, D-erythro-L-galacto-octitol, D-threo-L-galacto-octitol.

In particular, the at least one cyclitol may be selected from the group consisting of inositol (myo, scyllo-, D-chiro-, L-chiro-, muco-, neo-, allo-, epi- and cis-inositol), 1,2,3,4-tetra hydroxycyclohexane, 1,2,3,4,5-pentahydroxycyclohexane, quercitol, viscumitol, bornesitol, conduritol, ononitol, pinitol, pinpollitol, quebrachitol, ciceritol, quinic acid, shikimic acid and valienol: myo-inositol is preferred here.

Other suitable costabilizers are ester and ether derivatives of the stated alditols or cyclitols, such as the following compounds:

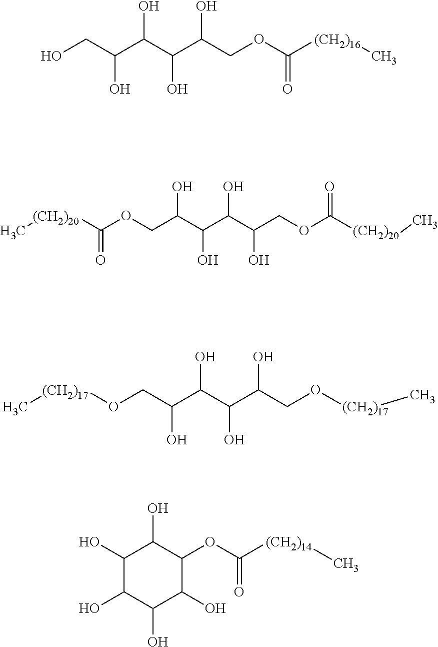

Suitable UV absorbers are, for example, compounds based on 2-(2′-hydroxyphenyl)benzotriazoles, 2-hydroxybenzophenones, esters of benzoic acids, acrylates, oxamides and 2-(2-hydroxyphenyl)-1,3,5-triazines.

Suitable 2-(2′-hydroxyphenyl)benzotriazoles are, for example, 2-(2′-hydroxy-5′methylphenyl)benzotriazole, 2-(3′,5′-di-tert-butyl-2′-hydroxyphenyl)benzotriazole, 2-(5′-tert-butyl-2′-hydroxy-phenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl-5-chlorobenzotriazole, 2-(3′-sec-butyl-5′-tert-butyl-2′-hydroxy-phenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the product of the transesterification of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂—]—₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole.

Suitable 2-hydroxybenzophenones are, for example, 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethyoxy derivatives of 2-hydroxybenzophenones.

Suitable acrylates are, for example, ethyl-α-cyano-β,β-diphenyl acrylate, isooctyl-α-cyano-β,β-diphenyl acrylate, methyl-α-carbomethoxycinnamate, methyl-α-cyano-β-methyl-p-methoxycinnamate, butyl-α-cyano-β-methyl-p-methoxycinnamate, methyl-α-carbomethoxy-p-methoxycinnamate and N-(β-carbomethoxy-β-cyanovinyl)-2-methylindoline.

Suitable esters of benzoic acids are, for example, 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl-3,5-di-tert-butyl-4-hydroxybenzoate, hexadecyl-3,5-di-tert-butyl-4-hydroxybenzoate, octadecyl-3,5-di-tert-butyl-4-hydroxybenzoate, 2-methyl-4,6-di-tert-butylphenyl-3,5-di-tert-butyl-4-hydroxybenzoate.

Suitable oxamides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and mixtures thereof with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Suitable 2-(2-hydroxyphenyl)-1,3,5-triazines are, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)-phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl-1,3,5-triazine.

Suitable metal deactivators are, for example, N,N′-diphenyloxamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyldihydrazide, oxanilide, isophthaloyldihydrazide, sebacoylbisphenylhydrazide, N,N′-diacetyladipoyldihydrazide, N,N′-bis(salicyloyl)oxylyldihydrazide, N,N′-bis(salicyloyl)thiopropionyldihydrazide, and tris[2-tert-butyl-4-thio-(2′-methyl-4′-hydroxy-5′-tert-butyl)-phenyl-5-methyl]phenylphosphite.

Particularly preferred metal deactivators are:

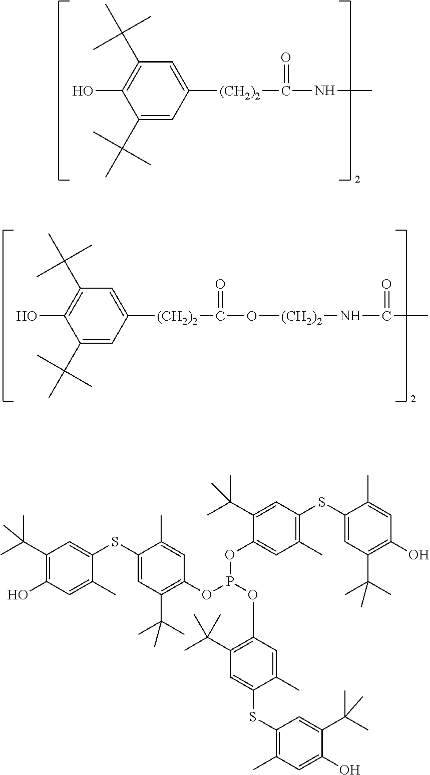

Suitable hindered amines are, for example, 1,1-bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylene diamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, linear or cyclic condensation products of N,N′-bis(2,2,6,6-tetramethyl-4-piperidyl)hexamethylene diamine and 4-morpholino-2,6-dichloro-1,3,5-triazine, and the reaction product of 7,7,9,9-tetramethyl-2-cycloundecyl-1-oxa-3,8-diaza-4-oxospiro-[4,5]decane and epichlorohydrin.

The above-mentioned structures also include, in each case, the sterically hindered N—H, N-alkyl, such as N-methyl or N-octyl, the N-alkoxy derivatives, such as N-methoxy or N-octyloxy, the cycloalkyl derivatives, such as N-cyclohexyloxy and the N-(2-hydroxy-2-methylpropoxy) analogues.

Particularly preferred hindered amines are the following:

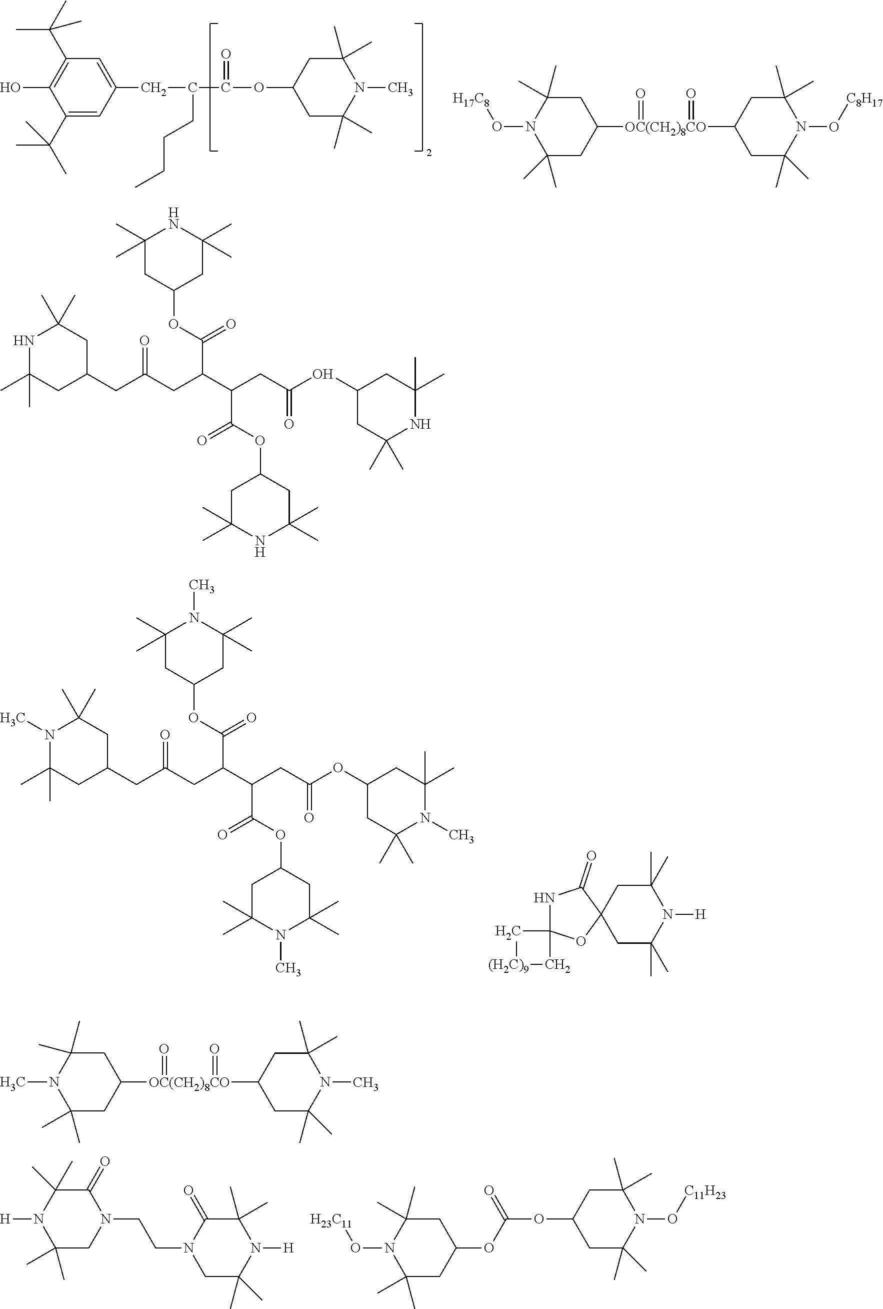

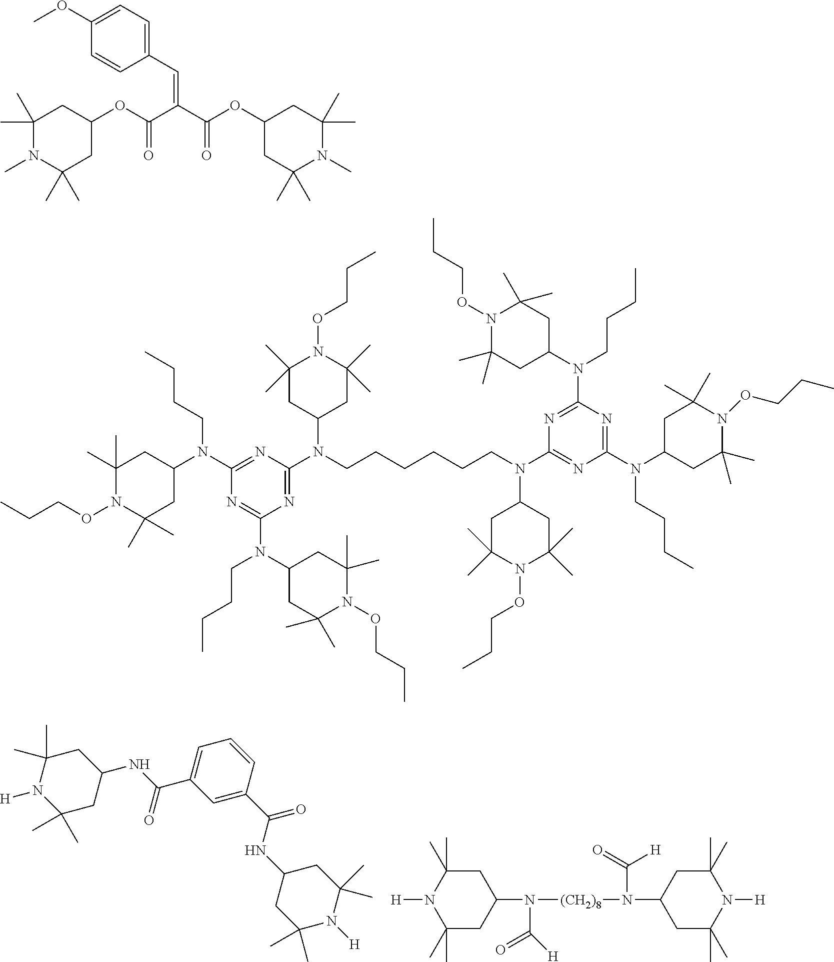

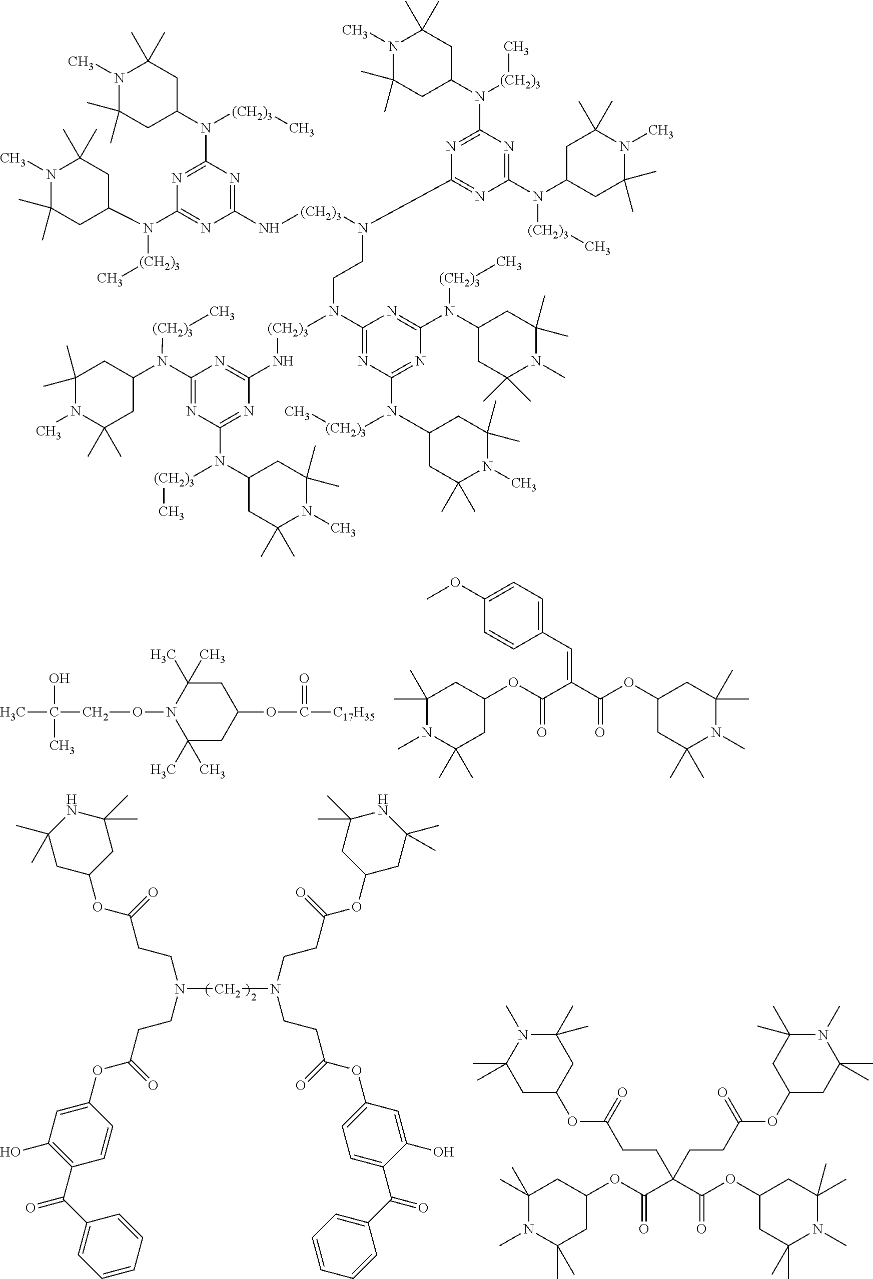

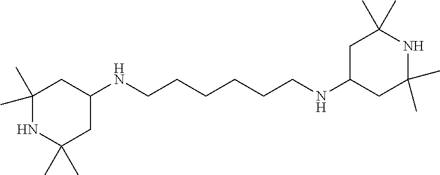

Preferred oligomeric and polymeric hindered amines have the following structures:

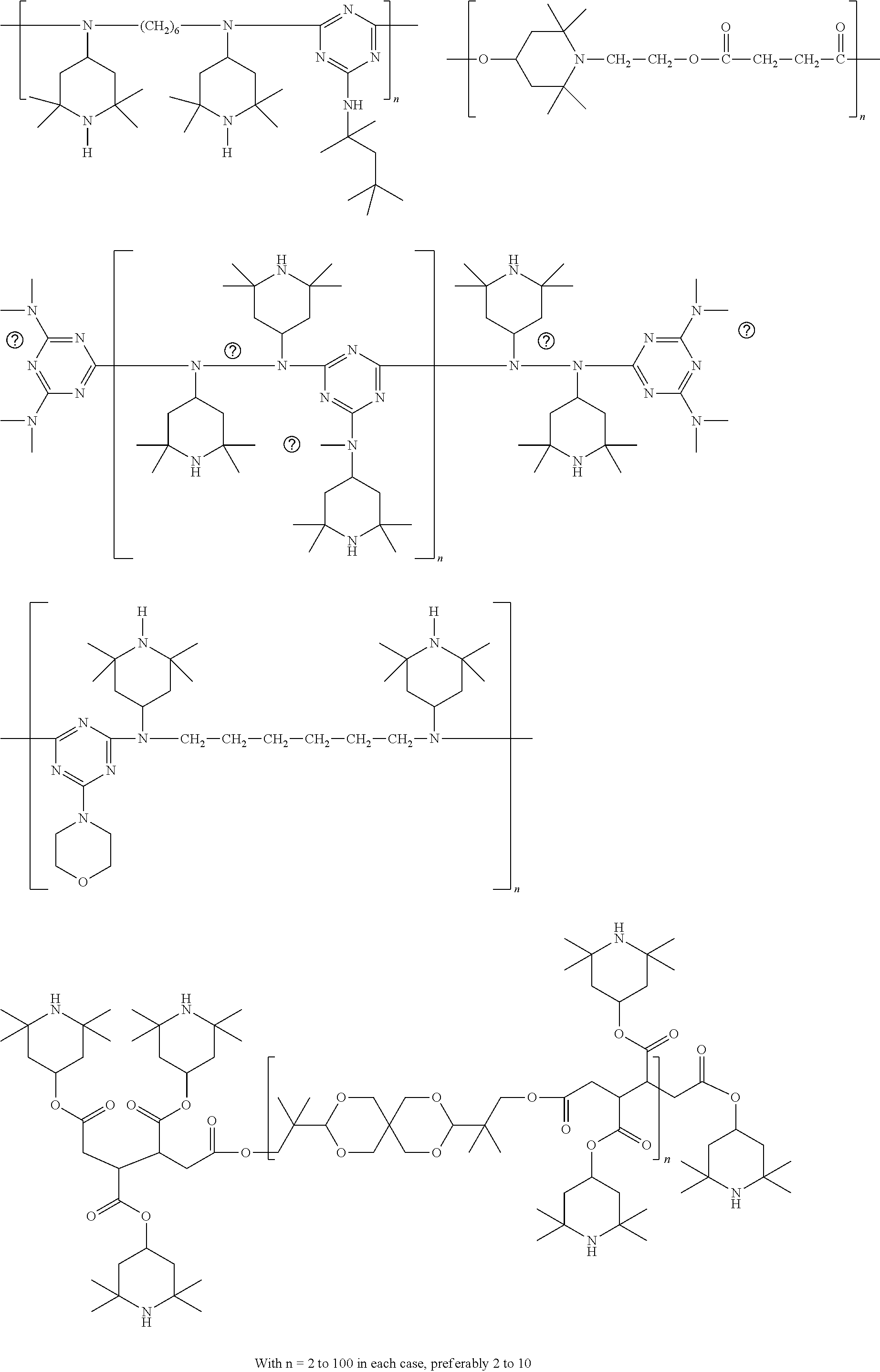

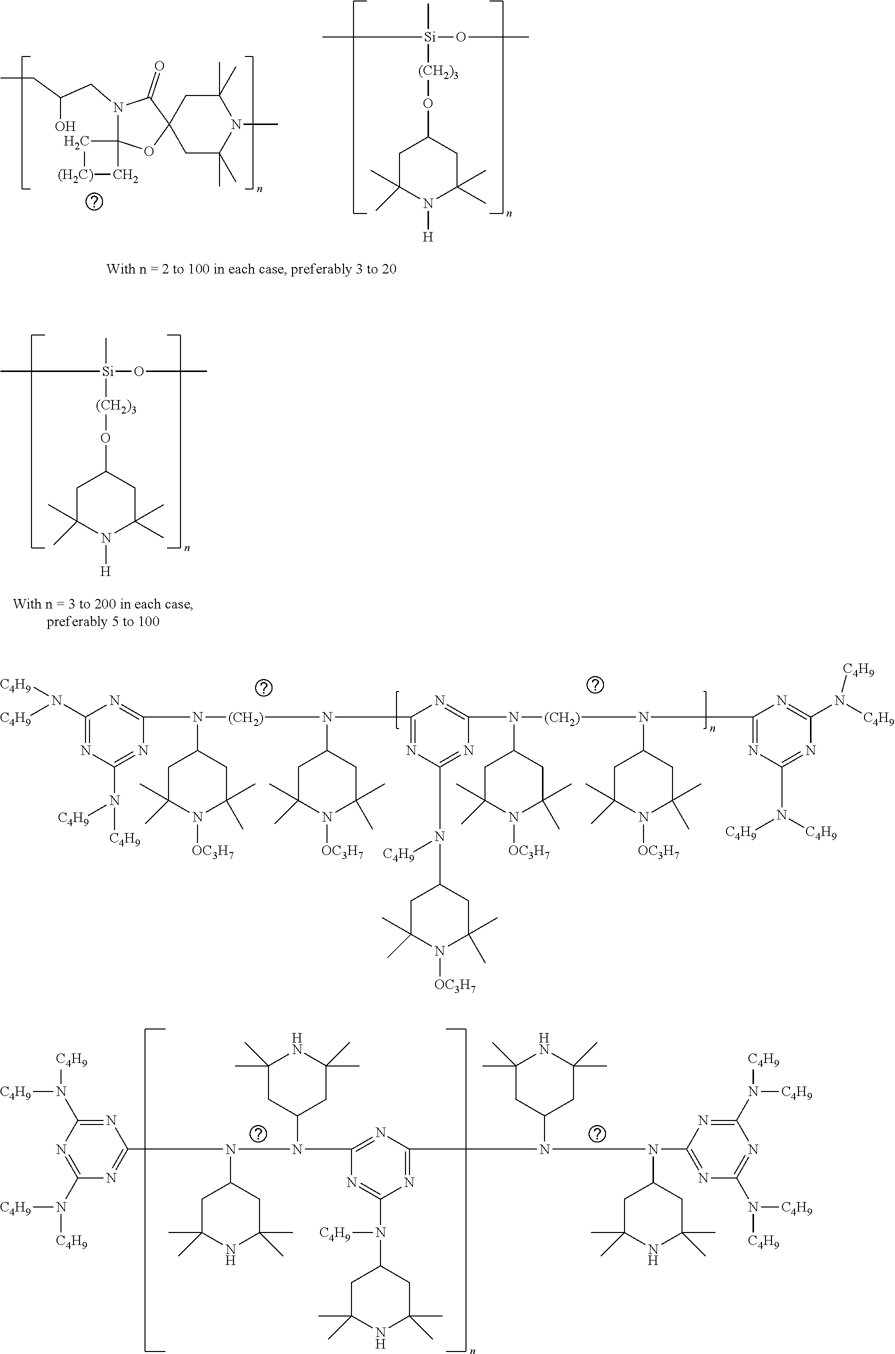

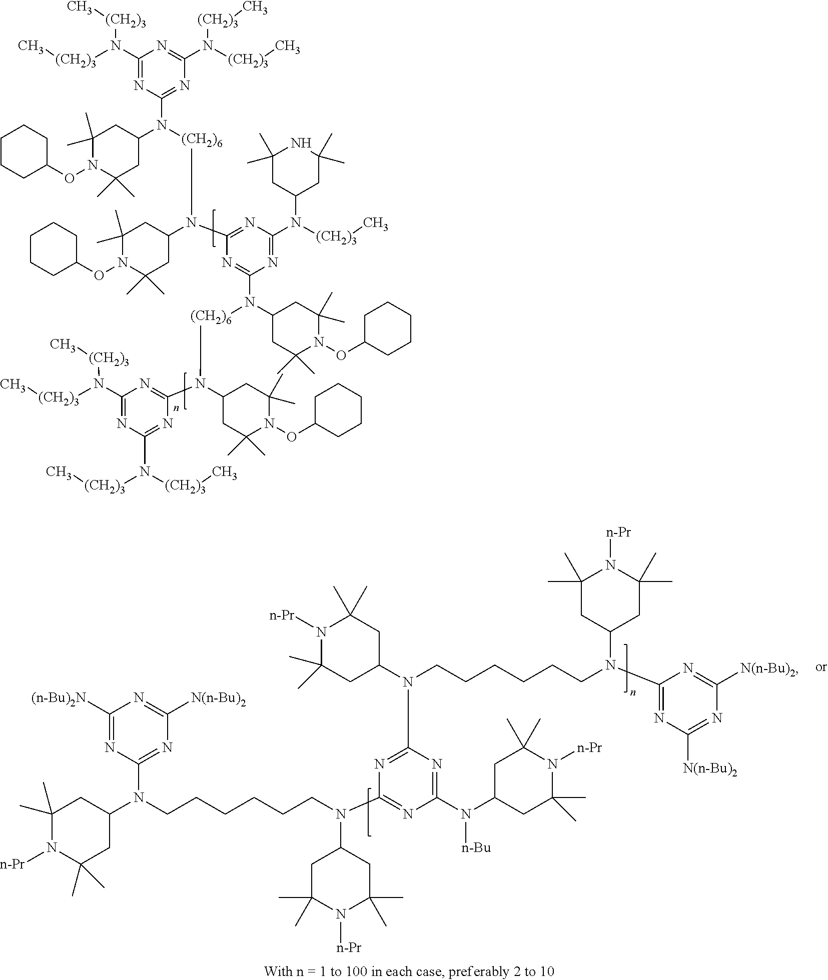

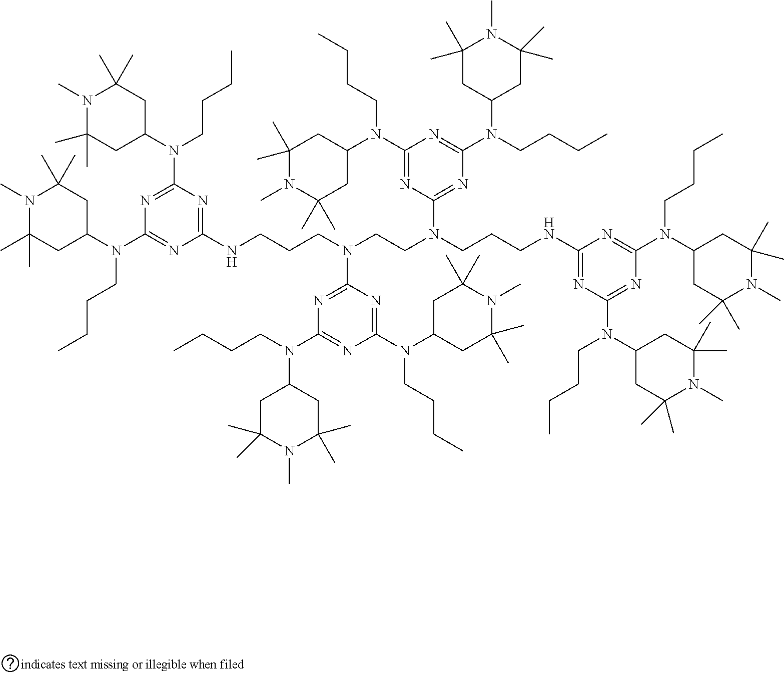

Another suitable light stabilizer is Hostanox NOW (manufacturer: Clariant SE) with the following general structure:

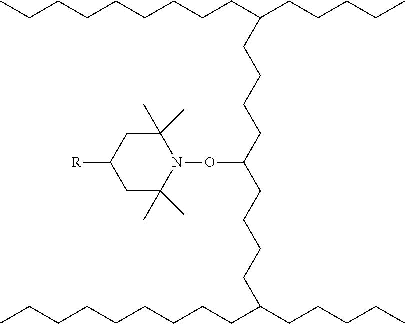

wherein R means —O—C(O)—C₁₅H₃₁ or —O—C(O)—C₁₇H₃₅.

Compatibilizers are used, for example, in thermodynamically immiscible blends or also in recyclate mixtures and contain structural elements of the respective blend components that are mixed. Suitable compatibilizers for polyolefin mixtures are, for example, olefin block copolymers, consisting of ethylene, propylene and alpha-olefins such as 1-octene. Other compatibilizers, in particular for compatibilizing polar polymers such as PET or polyamides and non-polar polymers such as PP or PE, often contain reactive groups derived, for example, from maleic anhydride, acrylic acid, glycidyl acrylate or glycidyl methacrylate and are, for example, polypropylene-g-maleic anhydride, polyethylene-g-maleic anhydride, polypropylene-g-acrylic acid, polyethylene-g-acrylic acid, poly(ethylene-co-maleic anhydride), SEBS-g-maleic anhydride, polyethylene-polyacrylate-polyglycidyl methacrylate.

Suitable dispersants are, for example:
polyacrylates, for example copolymers with long-chain side groups, polyacrylate block copolymers, alkylamides: for example N,N′-1,2-ethanediylbisoctadecanamide sorbitan esters, for example monostearyl sorbitan esters, titanates and zirconates, reactive copolymers with functional groups, for example polypropylene-co-acrylic acid, polypropylene-co-maleic anhydride, polyethylene-co-glycidyl methacrylate, polystyrene-alt-maleic anhydride polysiloxanes: for example dimethylsilanediol-ethylene oxide copolymer, polyphenylsiloxane copolymer, amphiphilic copolymers: for example polyethylene-block-polyethylene oxide, and dendrimers, for example dendrimers containing hydroxyl groups.

Suitable flame retardants are, in particular
a) inorganic flame retardants, such as Al(OH)₃, Mg(OH)₂, AlO(OH), MgCO₃, layered silicates, such as montmorillonite or sepiolite, unmodified or organically modified, double salts, such as Mg—Al-silicates, POSS (Polyhedral Oligomeric Silsesquioxane) compounds, huntite, hydromagnesite or halloysite as well as Sb₂O₃, Sb₂O₅, MoO₃, zinc stannate, and zinc hydroxystannate,
b) nitrogenous flame retardants such as melamine, melem, melam, melon, melamine derivatives, melamine condensation products or melamine salts, benzoguanamine, polyisocyanurates, allantoin, phosphacenes, in particular melamine cyanurate, melamine phosphate, dimelamine phosphate, melamine pyrophosphate, melamine polyphosphate, melamine metal phosphates such as melamine aluminum phosphate, melamine zinc phosphate, melamine magnesium phosphate, and the corresponding pyrophosphates and polyphosphates, poly-[2,4-(piperazin-1,4-yl)-6-(morpholin-4-yl)-1,3,5-triazine], ammonium polyphosphate, melamine borate, and melamine hydrobromide,
c) radical formers, such as alkoxyamines, hydroxylamine esters, azo compounds, sulfenamides, sulfenimides, dicumyl or polycumyl, hydroxyimides and their derivatives, such as hydroxyimide esters or hydroxyimide ethers,
d) phosphorus-containing flame retardants, such as red phosphorus, phosphates, such as resorcinol diphosphate, bisphenol A diphosphate and its oligomers, triphenyl phosphate, ethylenediamine diphosphate, phosphinates, such as salts of hypophosphorous acid and their derivatives, such as alkyl phosphinate salts, for example diethyl phosphinate aluminum or diethyl phosphinate zinc or aluminum phosphinate, aluminum phosphite, aluminum phosphonate, phosphonate esters, oligomeric and polymeric derivatives of methane phosphonic acid, 9,10-dihydro-9-oxa-10-phosphorylphenanthrene-10-oxide (DOPO) and substituted compounds thereof,
e) halogen-containing chlorine- and bromine-based flame retardants, such as polybrominated diphenyl oxides, such as decabromodiphenyloxide,tris(3-bromo-2,2-bis(bromomethyl)propyl-phosphate, tris(tribromneopentyl)phosphate, tetrabromophthalic acid, 1,2-bis(tribromophenoxy)ethane, hexabromocyclododecane, brominated diphenylethane, tris-(2,3-dibromopropyl)isocyanurate, ethylene-bis(tetrabromophthalimide), tetrabromo-bisphenol A, brominated polystyrene, brominated polybutadiene or polystyrene-brominated polybutadiene copolymers, brominated polyphenylene ether, brominated epoxy resin, polypentabromobenzyl acrylate, optionally in combination with Sb₂O₃ and/or Sb₂O₅,
f) borates, such as zinc borate or calcium borate, optionally on a carrier material such as silica,
g) sulfur-containing compounds, such as elemental sulfur, disulfides and polysulfides, thiuram sulfide, dithiocarbamates, mercaptobenzthiazole and sulfenamides, h) anti-drip agents, such as polytetrafluoroethylene,
i) silicon-containing compounds, such as polyphenylsiloxanes,
j) carbon modifications, such as carbon nanotubes (CNT), expanded graphite or graphene
k) and combinations or mixtures thereof.

Particularly suitable flame retardants are:
radical formers preferably selected from the group consisting of N-alkoxyamines, —C-C-radical formers, radical formers with azo groups (—N═N—), radical formers with hydrazine groups (—NH—HN—), radical formers with hydrazone groups (>C═N—NH—), radical formers with azine groups (>C═N—N═C<), and radical formers with triazene groups (—N═N—N<) or from iminoxytriazines.

The preparation of suitable azo compounds is described, for example, in M. Aubert et. al. Macromol. Sci. Eng. 2007, 292, 707-714 or in WO 2008/101845; the preparation of hydrazones and azines is described in M. Aubert et al., Pol. Adv. Technol. 2011, 22, 1529-1538; the preparation of triazenes is described in W. Pawelec et al., Pol. Degr. Stab. 2012, 97, 948-954. The synthesis of iminoxytriazines is described in WO 2014/064064.

Radical formers to be used in particular are selected here from the group consisting of
a) N-alkoxyamines according to the structural formula shown below

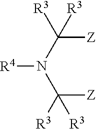

wherein
R³ represents hydrogen or an optionally substituted alkyl, cycloalkyl, aryl-heteroaryl or acyl group, in particular a C1 to C4 alkyl group,
R⁴ represents an alkoxy, aryloxy, cycloalkoxy, aralkoxy or acyloxy group,
Z represents hydrogen or an optionally substituted alkyl, cycloalkyl, aryl-heteroaryl or acyl group, wherein the two groups Z may also form a closed ring, which may optionally be substituted by ester, ether, amine, amide, carboxy or urethane groups,
E represents an alkoxy, aryloxy, cycloalkyloxy, aralkoxy or acyloxy group,
b) azo compounds according to the structural formulas shown below

R⁵—N═N—R⁵ or

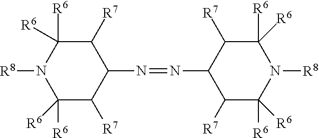

wherein
R⁵ means an alkyl, cycloalkyl or aryl group,
R⁶ is the same or different at each occurrence and means a linear or branched alkyl group,
R⁷ is the same or different at each occurrence and means hydrogen or a linear or branched alkyl group, and
R⁸ is the same or different at each occurrence and is an alkyl, alkoxy, aryloxy-cycloalkyloxy, aralkoxy or acyloxy group,
c) dicumyl according to the structural formula shown below

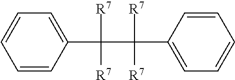

wherein R⁷ has the meaning given above, is preferably methyl,
d) and/or polycumyl according to the structural formula shown below

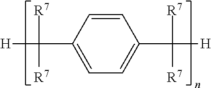

wherein R⁷ has the meaning given above, is preferably methyl, and 2<n<100.

Typical examples of the aforementioned N-alkoxyamines of the indicated structure are:
1-cyclohexyloxy-2,2,6,6-tetramethyl-4-octadecylaminopiperidine: bis(1-octyloxy-2,2,6,6-tetramethylpiperidin-4-yl) sebacate; 2,4-bis[(1-cyclohexyloxy-2.2.6.6-tetramethylpiperidin-4-yl)butylamino]-6-(2-hydroxyethylamino-S-triazine; bis(1-cyclohexyloxy-2,2,6,6-tetramethylpiperidin-4-yl) adipate;
2,4-bis[(1-cyclohexyloxy-2,2,6,6-tetramethylpiperidin-4-yl)butylamino]-6-chloro-S-triazine; 1-(2-hydroxy-2-methylpropoxy)-4-hydroxy-2,2,6,6-tetramethylpiperidine; 1-(2-hydroxy-2-methylpropoxy)-4-oxo-2,2,6,6-tetramethylpiperidine; 1-(2-hydroxy-2-methylpropoxy)-4-octadecanoyloxy-2,2,6,6-tetramethylpiperidine; bis(1-(2-hydroxy-2-methylpropoxy)-2,2,6,6-tetramethylpiperidin-4yl)sebacate; bis(1-(2-hydroxy-2-methylpropoxy)-2,2,6,6-tetramethylpiperidin4-yl)adipate; 2,4-bis{N-[1-(2-hydroxy-2-methylpropoxy)-2,2,6,6-tetramethylpiperidin-4-yl]-N-butylamino}-6-(2-hydroxyethylamino)-S-triazine); 4-piperidinol, 2,2,6,6-tetramethyl-1-(undecyloxy)-4,4′-carbonate; the reaction product of 2,4-bis[(1-cyclohexyloxy-2,2,6,6-tetramethylpiperidin-4-yl)butylamino]-6-chloro-S-triazine with N,N′-bis(3-aminopropylethylenediamine); the oligomer compound which is the condensation product of 4,4′-hexamethylene-bis(amino-2,2,6,6-tetramethylpiperidine) and 2,4-dichloro-6-[(1-cyclohexyloxy-2,2,6,6-tetramethyl-4-yl)butylamino]-S-triazine, terminated at the ends by 2-chloro-4,6-bis(dibutylamino)-S-triazine; aliphatic hydroxylamine, such as disterarylhydroxylamine; and compounds of the following formulas.

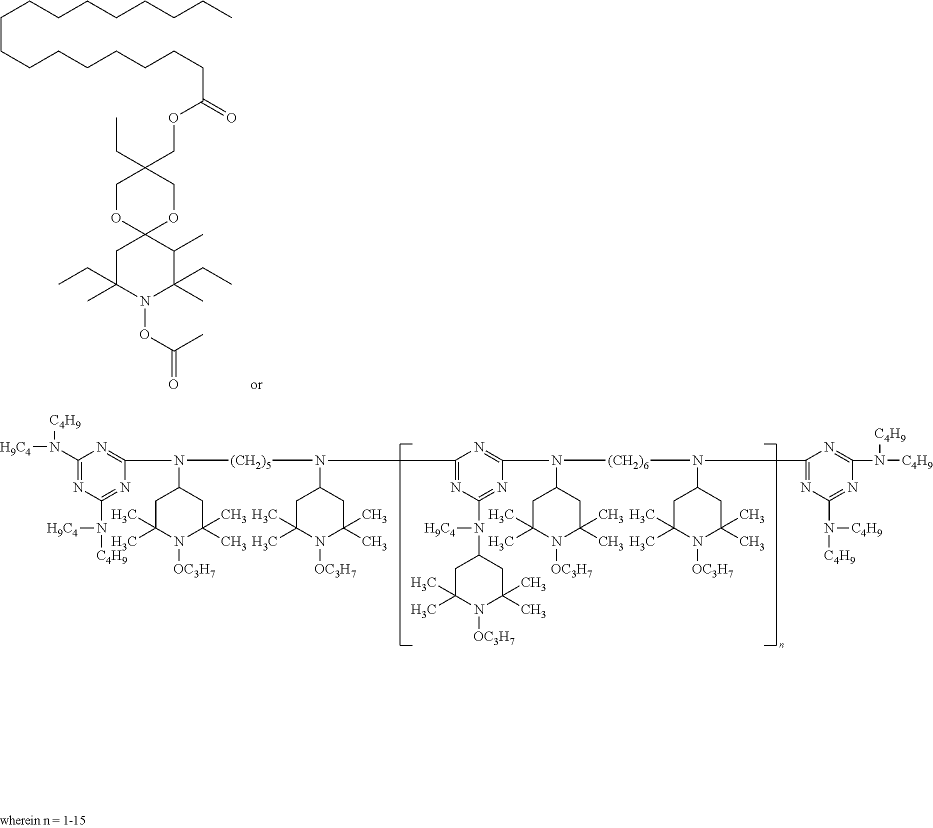

The above-stated compounds are partly commercial products and are traded under the following trade names: FLAMESTAB NOR 116®, TINUVIN NOR 371®, IRGATEC CR 76® from BASF SE, Hostavin NOW® from Clariant or ADK Stab LA 81® from Adeka. Dicumyl and polycumyl are commercial products available, for example, from United Initiators.

b) Phosphorus-containing flame retardants, e.g. phosphinates of the following structures:

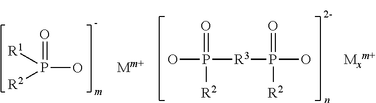

wherein preferably R1 and R2 are identical or different and are selected from linear or branched C1-C6 alkyl and/or aryl; M is selected from the group consisting of Mg, Ca, Al, Sb, Sn, Ge, Ti, Fe, Zr, Ce, Bi, Sr, Mn, Li, Na, K, Zn and/or a protonated nitrogen base, preferably calcium ions, magnesium ions, aluminum ions, and/or zinc ions; and m=1-4, preferably 2 or 3; n=1-4, preferably 1 or 3; x=1-4, preferably 1 or 2. In a particularly preferred embodiment, R₁=alkyl, R₂=alkyl and M=Al or Zn.

A particularly preferred example of a phosphinate is constituted by the commercially available products Exolit OP® from Clariant SE.

Further preferred phosphorus-containing flame retardants are metal salts of hypophosphorous acid having a structure according to the formula

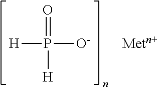

wherein Met is a metal selected from groups I, II, III and IV of the Periodic Table of the Elements, and n is a number from 1 to 4 corresponding to the charge of the corresponding metal ion Met. Metⁿ⁺ is for example Na⁺, Ca²⁺, Mg²⁺, Zn²⁺, Ti⁴⁺ or Al³⁺, wherein Ca²⁺, Zn²⁺ and Al³⁺ are particularly preferred.

Some of the above-mentioned salts of hypophosphorous acid are commercially available, e.g., under the name Phoslite® from Italmatch Chemicals.

Another preferred group of phosphorus-containing flame retardants are phosphonates or diaryl phosphonic acid esters of a structure according to the following formula:

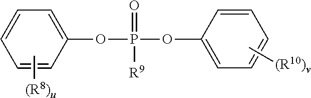

wherein R₈ and R₁₀=H, alkyl, preferably C1-C4, R₉=C1-C4 alkyl, u=1-5st and v=1-5.

Corresponding structures may also be in the form of phosphonate oligomers, polymers and co-polymers. Linear or branched phosphonate oligomers and polymers are known from the prior art. For branched phosphonate oligomers and polymers, reference is made to U.S. Pat. Nos. 2,716,101, 3,326,852, 4,328,174, 4,331,614, 4,374,971, 4,415,719, 5,216,113, 5,334,692, 3,442,854, 6,291,630 B1, 6,861,499 B2 and 7,816,486 B2. For phosphonate oligomers, reference is made to US patent applications US 2005/0020800 A1, US 2007/0219295 A1 and US 2008/0045673 A1. With regard to linear phosphonate oligomers and polymers, reference is made to US patent documents, U.S. Pat. Nos. 3,946,093, 3,919,363, 6,288,210 B1, 2,682,522 and 2,891,915.

Phophonates are available, for example, under the trade name Nofia® from FRX Polymers.

Another preferred group of phosphorus-containing flame retardants are compounds based on oxaphosphorine oxide and their derivatives with, for example, the following structures:

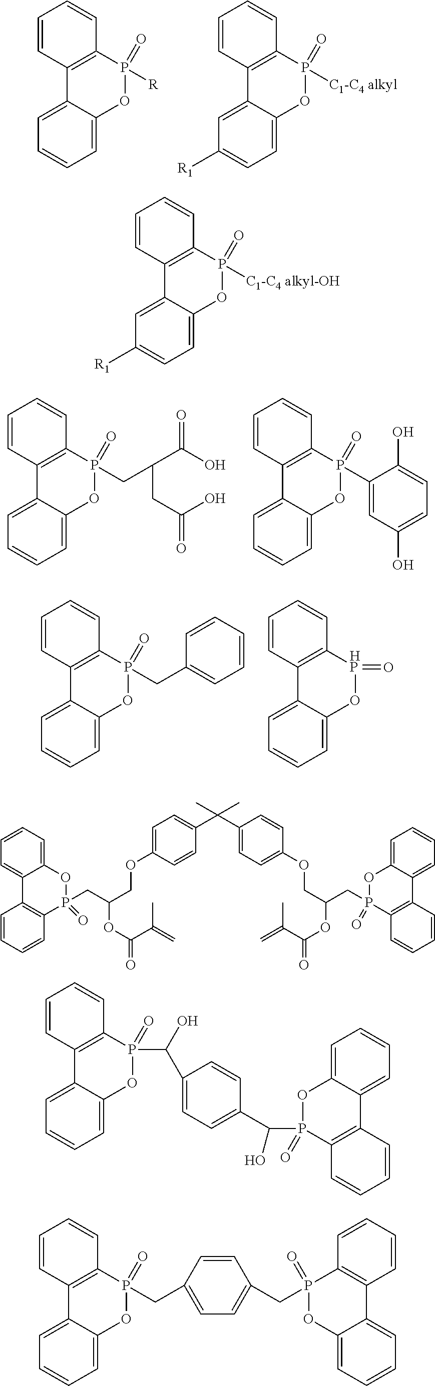

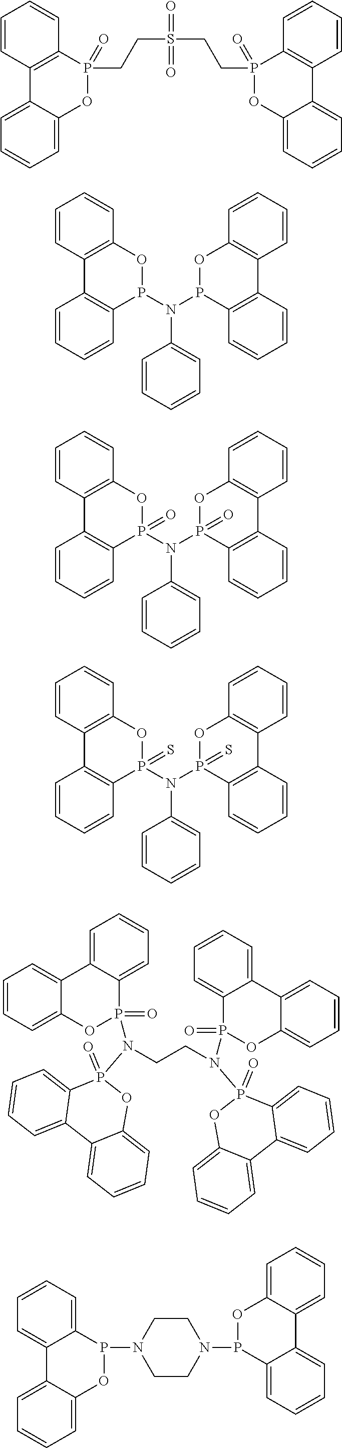

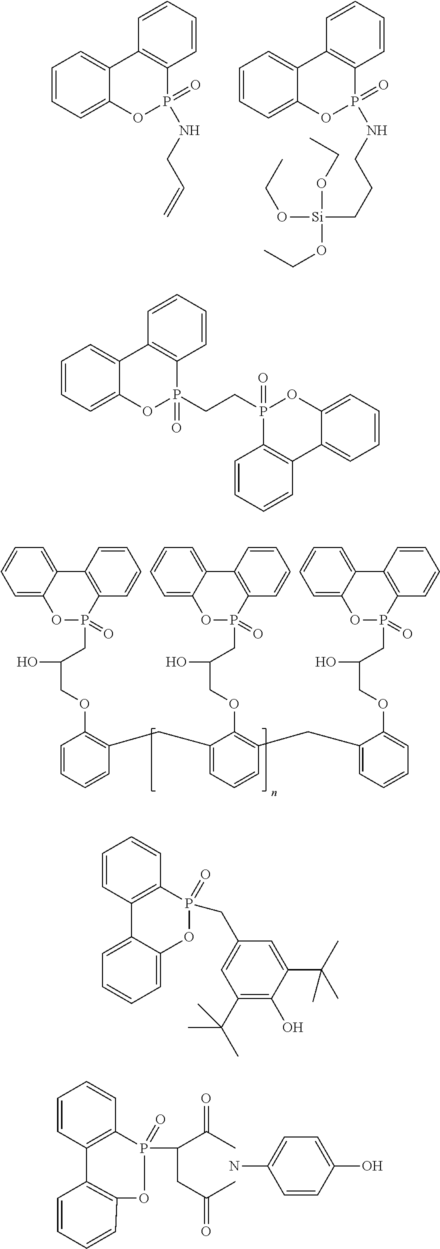

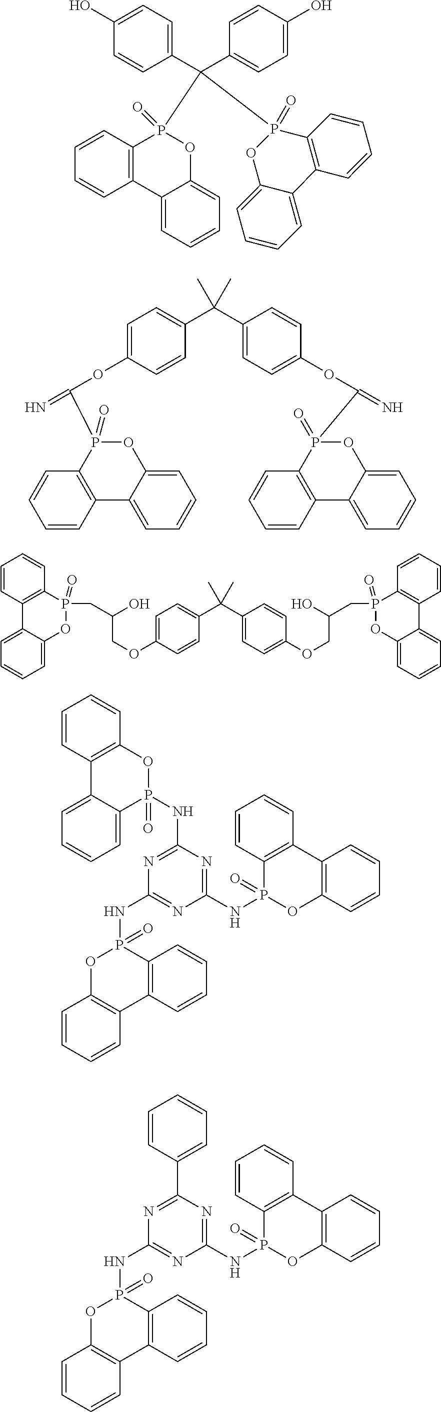

wherein M is a metal selected from the second, third, twelfth or thirteenth groups of the Periodic Table of the Elements, x=2 or 3, n≥10, m=0-25, R=H, halogen or an aliphatic or aromatic group having 1-32 C atoms and R₁=H, C₁-C₆ alkyl or phenyl.

Products based on oxophosphorine oxide are, for example, available under the trade name Ukanol® from Schill und Seilacher GmbH. Further compounds may be prepared, for example, according to patent specifications WO 2013020696, WO 2010135398, WO03070736, WO2006084488, WO 2006084489, WO 2011000019, WO 2013068437, WO 2013072295.

Other suitable phosphorus-containing flame retardants are cyclic phosphonates of a structure according to one of the following formulas:

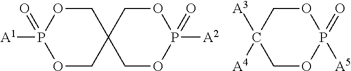

wherein A¹ and A² independently of one another represent a substituted or unsubstituted, straight-chain or branched alkyl group having 1 to 4 carbon atoms, substituted or unsubstituted benzyl, substituted or unsubstituted phenyl, substituted or unsubstituted naphthyl, and wherein A³ and A⁴ independently of one another are methyl or ethyl and A⁵ is a straight-chain or branched alkyl group having 1 to 4 carbon atoms or a phenyl or benzyl group, each of which may have up to 3 methyl groups.

Cyclic phosphonates are available, for example, from the company Thor GmbH under the trade name Aflammit® or may be prepared according to EP 2450401.

Other synergistic phosphorus-containing flame retardants are phosphacenes, in particular polymeric phosphacenes. A corresponding product is available, for example, under the name SPB-100 from Otsuka Chemicals.

### a) Nitrogenous Flame Retardants

Preferred nitrogen-containing flame retardants are melamine polyphosphate, melamine cyanurate, melamine metal phosphates, poly-[2,4-(piperazin-1,4-yl)-6-(morpholin-4-yl)-1,3,5-triazine] and ammonium polyphosphate. These compounds are commercial products and are available under the trade names Melapur® from BASF SE, Budit® from Budenheim Chemische Fabrik, Exolit® from Clariant, Safire® from Huber Chemicals or MCA PPM Triazine from MCA Technologies GmbH.

c) Preferred Sulfur-Containing Flame Retardants are, for Example, the Following Compounds

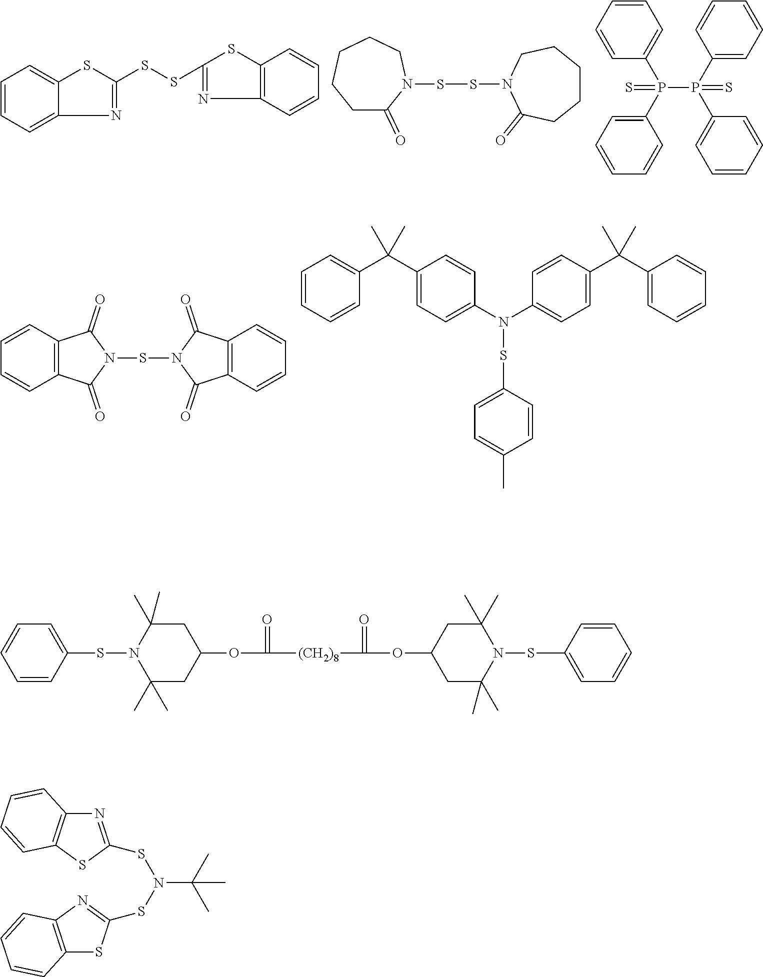

Very particularly preferred flame retardants are halogen-free and are the following compounds:

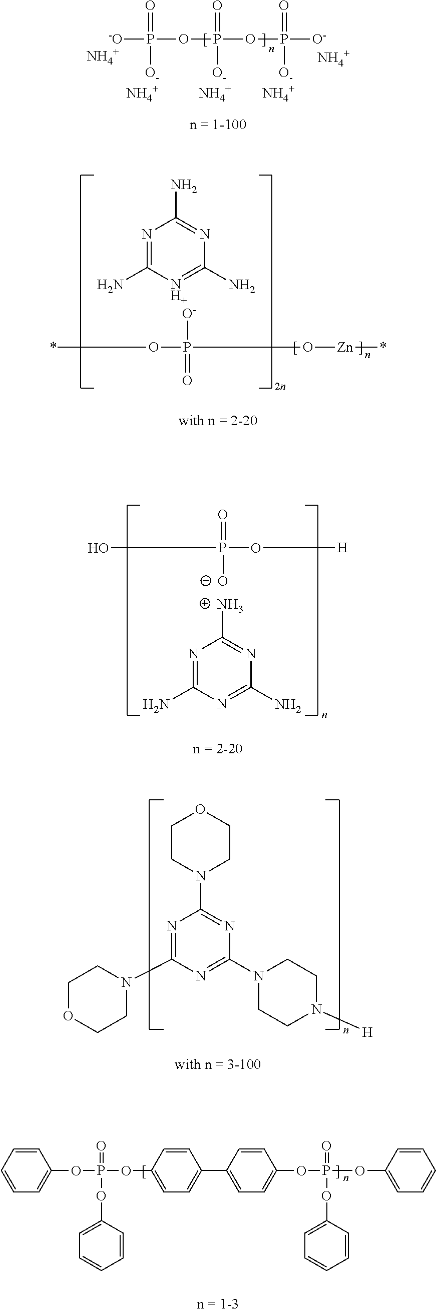

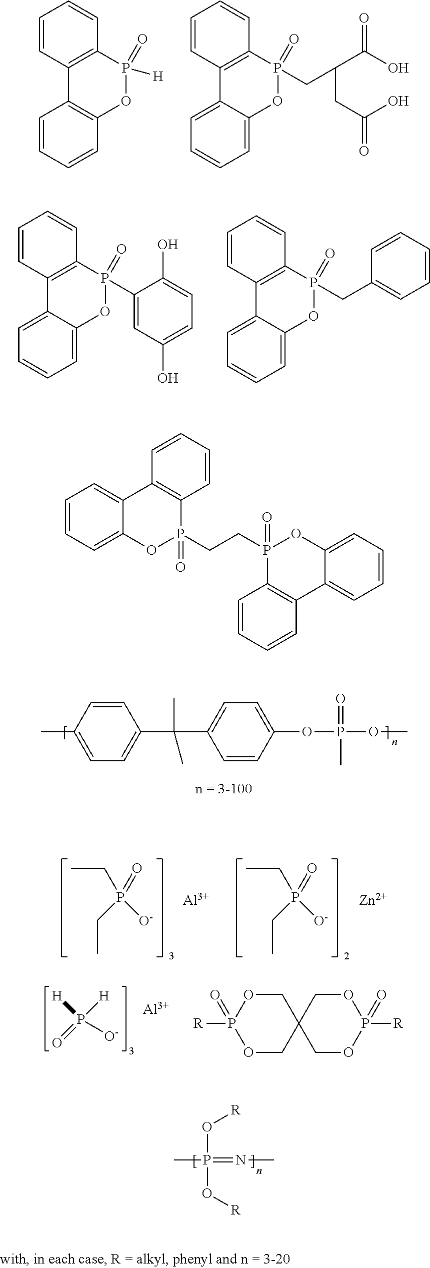

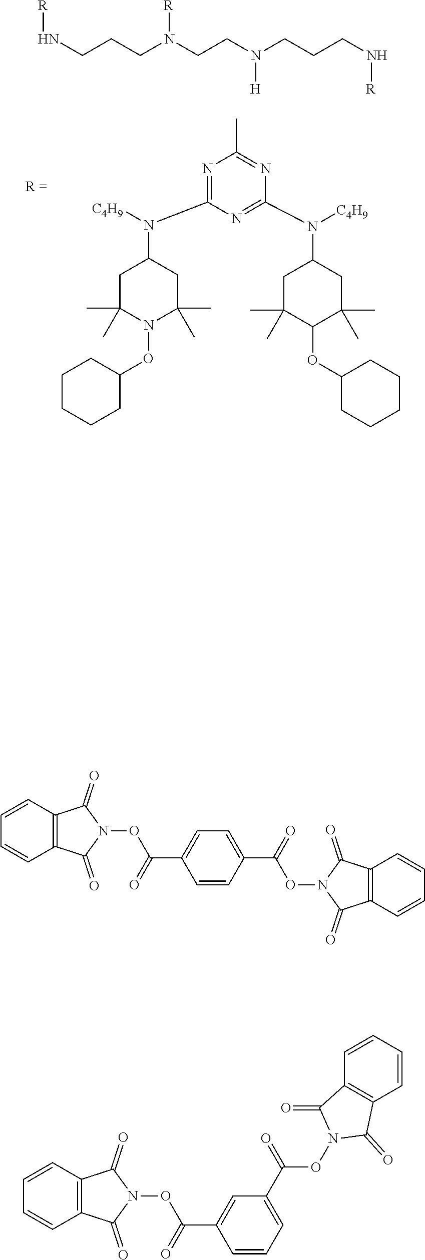

Suitable lubricants and processing aids are, for example, polyethylene waxes, polypropylene waxes, salts of fatty acids such as calcium stearate, zinc stearate or salts of montan waxes, amide waxes such as erucic acid amide or oleic acid amides, fluoropolymers, silicones or neoalkoxytitanates and zirconates.

Suitable heat stabilizers, in particular for PVC, are for example metal soaps of divalent metals such as Ba, Zn, Ca, e.g. zinc stearate, calcium stearate, organo tin compounds, e.g. methyl and octyl tin compounds such as dioctyl tin bis isooctyl thioglycolate or dioctyl tin maleate aminouracils, aminocrotonic acid esters, perchlorate salts and, as co-stabilizers, phosphites, epoxides, polyols, diketones, dihydropyridines, hydrotalcites, zeolites.

Suitable pigments may be inorganic or organic in nature. Inorganic pigments are, for example, titanium dioxide, zinc oxide, zinc sulfide, iron oxide, ultramarine, carbon black, organic pigments are, for example, anthraquinones, anthanthrones, benzimidazolones, quinacridones, diketopyrrolopyrroles, dioxazines, indanthrones, isoindolinones, azo compounds, perylenes, phthalocyanines or pyranthrones. Other suitable pigments are metal-based effect pigments or metal oxide-based pearlescent pigments. Other suitable pigments are C.I. pigments such as Black 12, Black 26, Black 28, Black 30, Blue 15, Blue 28, Blue 36, Blue 60, Blue 385, Brown 24, Brown 25, Brown 29, Brown 33, Green 7, Green 17, Green 26, Green 36, Green 47, Green 50, Violet 1, Violet 3, Violet 14, Violet 16, Violet 19, Violet 23, Violet 27, Yellow 1, Yellow 3, Yellow 12, Yellow 13, Yellow 14, Yellow 17, Yellow 53, Yellow 62, Yellow 74, Yellow 83, Yellow 95, Yellow 138, Yellow 147, Yellow 151, Yellow 154, Yellow 155, Yellow 164, Red 2, Red 3, Red 4, Red 8, Red 48, Red 49, Red 52, Red 53, Red 57, Red 81, Red 112, Red 122, Red 146, Red 169, Red 170, Red 254, Orange 5, Orange 13, Orange 23, Orange 34, and Orange 43.

Suitable optical brighteners are, for example bisbenzoxazoles, phenyl coumarins or bis(styryl)biphenyls and in particular optical brighteners of formulas:

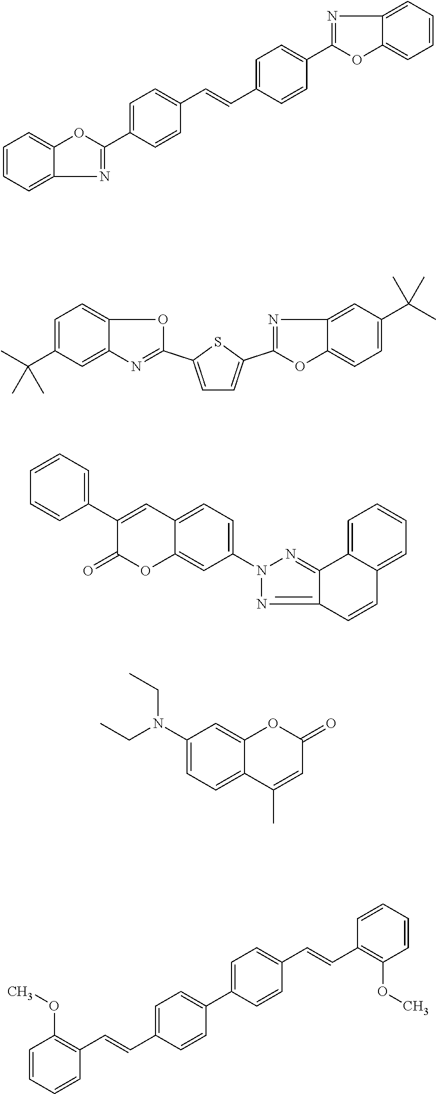

Suitable filler deactivators are, for example, polysiloxanes, polyacrylates, in particular block copolymers such as polymethacrylic acid-polyalkylene oxide or polyglycidyl (meth)acrylates and their copolymers, for example with styrene, and epoxides, for example of the following structures:

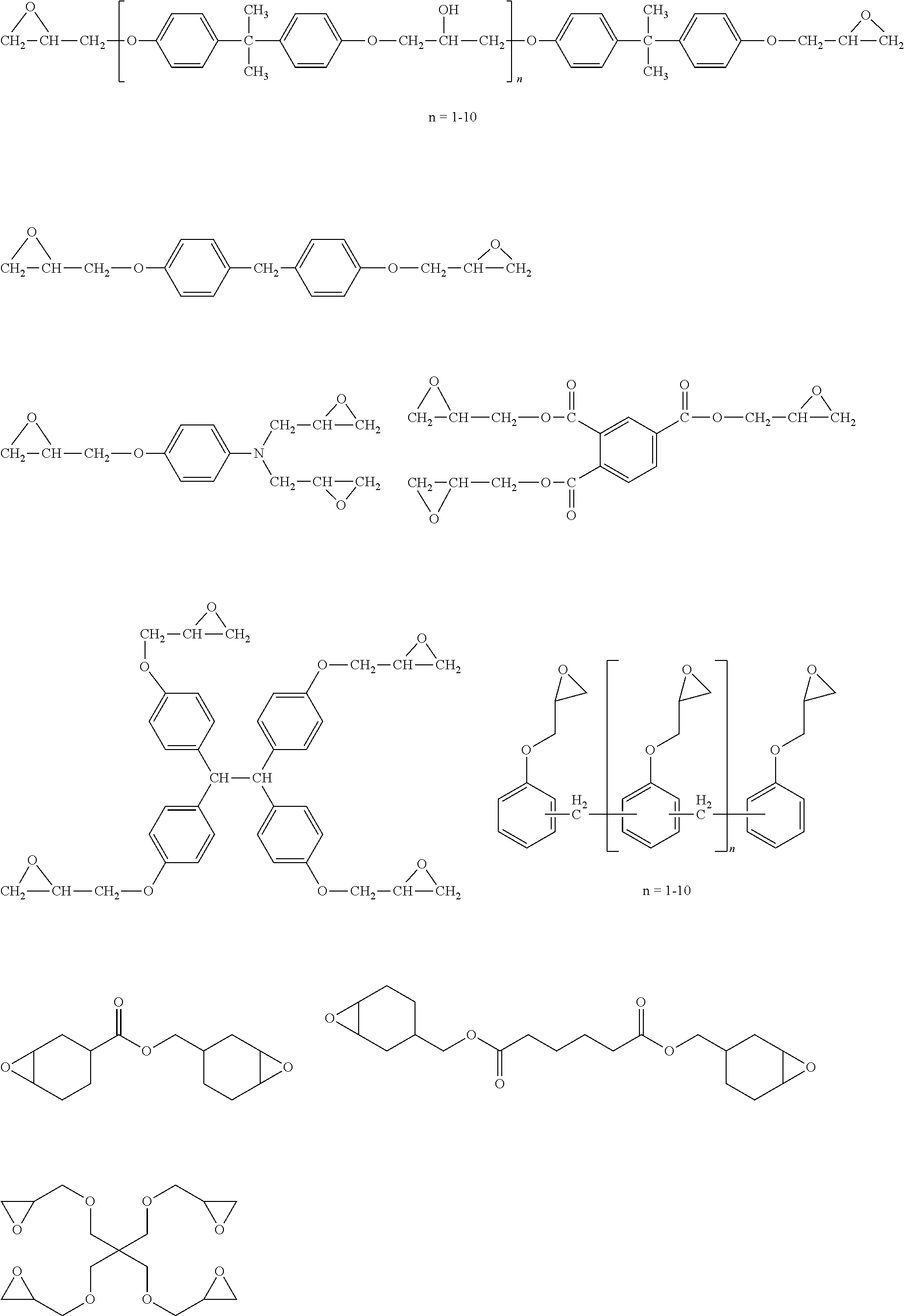

Suitable antistatic agents are, for example, ethoxylated alkylamines, fatty acid esters, alkyl sulfonates and polymers that form a co-continuous network with the polymer matrix, such as polyetheramides, polyesteramides, polyether ester amides or polyether block copolymers, optionally with the addition of ionically conducting metal salts.

Suitable antiozonants are the above-mentioned amines such as N,N′-diisopropyl-p-phenylenediamine, N,N′-di-sec-butyl-p-phenylenediamine, N,N′-bis(1,4-dimethylpentyl)-p-phenylenediamine, N,N′-dicyclohexyl-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine.

Suitable rheology modifiers e.g. for the preparation of controlled rheology polypropylene (CR-PP) are, for example, peroxides, alkoxyamine esters, oxyimide sulfonic acid esters and in particular the following structures:

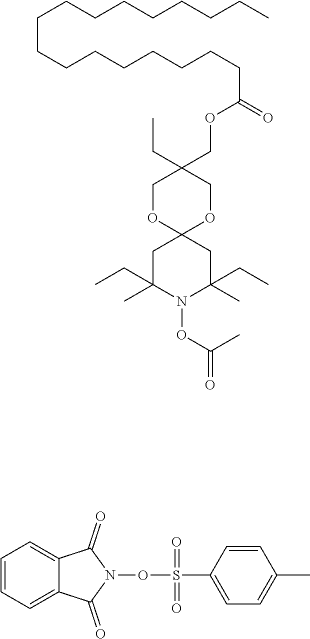 [SMILES: CCCCCCCCCCCCCCCCCC(=O)OCC1(CC)COC2(CC(C)(CC)N(OC(C)=O)C(C)(CC)C2)OC1 ; Cc1ccc(S(=O)(=O)ON2C(=O)c3ccccc3C2=O)cc1]

Suitable additives for the molecular weight build-up of polycondensation polymers (chain extenders) are diepoxides, bis-oxazolines, bis-oxazolones, bis-oxazines, diisocyanates, dianhydrides, bis-acyl lactams, bis-maleimides, dicyanates, carbodiimides and polycarbodiimides. Other suitable chain extenders are polymeric compounds, such as polystyrene-polyacrylate-polyglycidyl (meth)acrylate copolymers, polystyrene-maleic anhydride copolymers and polyethylene-maleic anhydride copolymers.

Suitable additives for increasing electrical conductivity are, for example, the aforementioned antistatic agents, carbon black and carbon compounds such as carbon nanotubes and graphene, metal powders, such as copper powder, and conductive polymers, such as polypyrrols, polyanilines and polythiophenes.

Suitable infrared-active additives are, for example, aluminosilicates, hydrotalcites or coloring agents such as phthalocyanines or anthraquinones.

Suitable crosslinking agents are, for example, peroxides like dialkyl peroxides, alkylaryl peroxides, peroxyesters, peroxycarbonates, diacylproxides, peroxyketals, silanes, such as vinyltrimethoxysilane, vinyltriethoxysilane, vinyltriacetoxysilane, vinyltris(2-methoxyethoxy)silane, 3-methacryloyloxypropyltrimethoxysilane, vinyldimethoxymethylsilane or ethylene-vinylsilane copolymers.

Suitable prodegradants are additives that specifically accelerate or control the degradation of a polymer in the environment. Examples are transition metal fatty acid esters, e.g. of manganese or iron, which accelerate an oxidative and/or photooxidative degradation for example of polyolefins or enzymes which induce a hydrolytic degradation for example of aliphatic polyesters.

Suitable chemical blowing agents are, for example, azo compounds such as azodicarboxylic acid diamide, sulfonyl semicarbazides such as p-toluenesulfonyl semicarbazide, tetrazoles such as 5-phenyl tetrazole, hydrazides such as p-toluenesulfonyl hydrazide, 4,4′-oxibis(benzenesulfonyl)hydrazide, N-nitroso compounds such as N,N′-dinitrosopentamethylene tetramine or carbonates such as sodium hydrogen carbonate or zinc carbonate.

Suitable slip agents include amide waxes such as erucic acid amide or oleic acid amide.

Suitable anti-blocking agents are, for example, silica, talc or zeolites.

Suitable antifogging additives are for example ethoxylated sorbitan esters, ethoxylated fatty acid alcohols or ethoxylated alkylamine esters.

Suitable biocides are, for example, quaternary ammonium salts or silver salts, colloidal silver or silver complexes or also derivatives of natural substances such as chitosan.

Suitable aldehyde scavengers are amines, hydroxylamines, polyvinyl alcohol, zeolites or cyclodextrins, suitable formaldehyde scavengers are melamine derivatives such as benzoguanamine or urea derivatives such as allantoin.

Suitable odor-binding or dour-preventing substances are silicates such as calcium silicate, zeolites or salts of hydroxy fatty acids such as zinc riceneolate.

Suitable marking agents are, for example, fluorescent dyes or rare earths.

Suitable nucleating agents are talc, alkali or alkaline earth salts of mono- and polyfunctional carboxylic acids, such as benzoic acid, succinic acid, adipic acid, for example sodium benzoate, zinc glycerolate, aluminum hydroxy-bis(4-tert-butyl)benzoate, 2,2′-methylene-bis-(4,6-di-tert-butylphenyl)phosphate, as well as trisamides and diamides, such as trimesic acid tricyclohexylamide, trimesic acid tri(4-methylcyclohexylamide), trimesic acid tri(tert.butylamide), N,N′,N″-1,3,5-benzenetriyltris(2,2-dimethyl-propanamide) or 2,6-naphthalenedicarboxylic acid dicyclohexylamide.

Suitable transparency enhancers (clarifiers) are in particular sorbitol derivatives such as

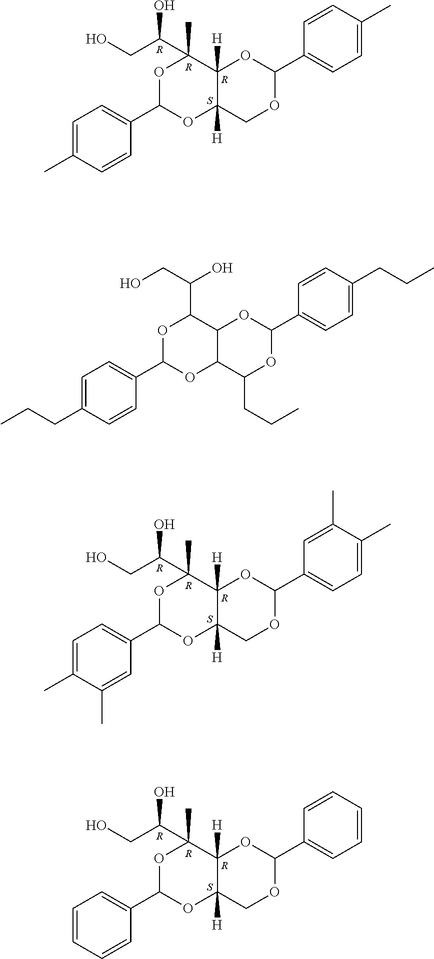

Suitable antinucleating agents are azine dyes such as nigrosine or ionic liquids,
Suitable additives for increasing the thermal conductivity of plastic recyclates are, for example, inorganic fillers such as boron nitride, aluminum nitride, aluminum oxide, aluminum silicate, silicon carbide but also carbon nanotubes (CNT).

Suitable impact modifiers are usually selected for the particular recyclate and are selected for example from the group of functionalized or non-functionalized polyolefins, such as ethylene copolymers such as EPDM or maleic anhydride or styrene-acrylonitrile-modified EPDM, glycidyl-methacrylate-modified ethylene-acrylate copolymers or also ionomers, core-shell polymers for example based on MBS (methacrylate-butadiene-styrene copolymer) or acrylester-polymethyl methacrylate, thermoplastic elastomers (TPE) for example based on styrene-block copolymers (styrene-butadiene (SB), styrene-butadiene-styrene (SBS) optionally hydrated (SEBS) or modified by maleic anhydride (SEBS-g-MAH), thermoplastic polyurethanes, copolyesters or copolyamides.

Suitable plasticizers are, for example, esters of phthalic acid, terephthalic acid, adipic acid, 1,2-cyclohexanedicarboxylic acid, trimellitic acid, citric acid or phosphoric acid such as benzyl butyl phthalate (BBP), butyl nonyl phthalate (BNP), didecyl phthalate (DDP), diisobutyl adipate (DIBA), diisodecyl adipate (DIDA), dioctyl terephthalate (DOTP), diisotridecyl phthalate (DTDP), tributyl O-acetyl citrate (TBAC), triethyl-O-acetyl citrate (TOAC), tetrahydrofurfuryl oleate (THFO), triisooctyl trimellitate (TIOTM), tributyl phosphate (TBP) and epoxidized soybean oil (ESO) or epoxidized linseed oil (ELO).

Suitable demolding aids are, for example, silicones, soaps and waxes such as montan waxes.

Preferably, the additive according to the invention, which may be present as a powder, liquid, oil, compacted, on a carrier material, as granules, solution or flakes, is mixed with the polymer to be stabilized, and the polymer matrix is transferred into the melt and then cooled. Alternatively, it is also possible to introduce the additive into a polymer melt in a molten state.

Furthermore, the additive compositions according to the invention may be prepared and incorporated in the form of so-called masterbatches or concentrates containing, for example, 10-90% of the compositions according to the invention in a polymer or a polymer recyclate.

In a further preferred embodiment, the compositions contain secondary antioxidants, in particular phosphites/phosphonites, sulfites, acid scavengers, costabilizers based on polyols and/or light stabilizers from the group of hindered amines (HALS).

In the aforementioned embodiment it is advantageous if the at least one additive is contained or is added in an amount from 0.01 to 80 wt. %, preferably from 0.01 to 9.99 wt. %, more preferably from 0.01 to 4.98 wt. %, particularly preferably from 0.02 to 2.00 wt. %, in relation to the total of the at least one polymer according to general formula I, the plastic and the at least one additive.

According to a further aspect, the present invention relates to a plastic composition containing at least one plastic and at least one polymer according to general formula I as defined above.

In a preferred embodiment, the plastic composition has the following composition:
0.01 to 10.00 wt. %, preferably 0.01 to 7.50 wt. %, more preferably from 0.02 to 5.00 wt. %, particularly preferably from 0.05 to 3.00 wt. % of a polymer according to general formula I,
99.99 to 10.00, preferably 99.99 to 90.00 wt. %, preferably 99.89 to 95.00 wt. %, particularly preferably 99.90 to 98.00 wt. % of at least one plastic, and
0 to 80.00 wt. %, preferably 0 to 9.99 wt. %, more preferably 0.01 to 4.98 wt. %, particularly preferably 0.02 to 2.00 wt. % of at least one additive,
wherein the constituents add up to 100 wt. %.

The at least one additive is preferably selected here from the group consisting of primary antioxidants, secondary antioxidants, UV absorbers, light stabilizers, in particular the hindered amines as light (HALS) and long-term heat stabilizers (HAS), metal deactivators, filler deactivators, antiozonants, nucleating agents, antinucleating agents, transparency improvers (clarifiers), impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde and formaldehyde scavengers, blowing agents, degradation additives (prodegradants), defoaming agents, odor scavengers, odor-improving substances, PVC heat stabilizers, marking agents, antifogging agents, gloss improvers, mattifying agents, additives for increasing the electrical and/or thermal conductivity, repellents, fillers and reinforcing agents and mixtures hereof.

Particularly preferred plastic compositions consist of
(A) 0.02-4, particularly preferably 0.05-2 parts of at least one polymer according to general formula I as defined above,
(B) 43-99.96 parts of a plastic,
(C) 0.02-4 parts, particularly preferably 0.05-2 parts of a
   (a) phosphite or phosphonite and/or
   (b) sulfite and/or
   (c) polyol and/or
   (d) acid scavenger and/or
   (e) hindered amine
(D) 0-50 parts, particularly preferably 0-2 parts of a further additive,
so that 100 parts are obtained.

In the event that further constituents are added to the plastic composition (synonymous with this: polymer composition), these can be added to the polymers separately, in the form of liquids, powders, granular materials or compacted products or together with the additive composition according to the invention (i.e. the at least one polymer according to general formula I and, if appropriate, additives) as described above.

The incorporation of the additive composition described above and, if necessary, the additional additives into the plastic is carried out by conventional processing methods, preferably by mixers, kneaders or extruders. Preferred processing machines are extruders, such as single-screw extruders, twin-screw extruders, planetary roller extruders, ring extruders, and co-kneaders, which are preferably equipped with vacuum degassing. The processing may take place here under air or, if necessary, under inert gas conditions.

The plastic compositions containing the described additive composition may be processed by conventional plastics processing methods in continuous and discontinuous processes, such as extrusion, calendering, blow molding, pultrusion, injection molding, pressing, transfer molding, casting, blow molding, rotational molding, thermoforming, sintering, foaming or also by additive manufacturing processes for the production of granular material, molded parts, semi-finished products, fibers and films.

Suitable extruders are piston extruders and screw extruders, single-screw extruders, twin-screw extruders, multi-screw extruders, planetary roller extruders, in particular for the production of plastics granular materials, pipes, rods, tubes, profiles, sheathing, board, films, V-belts, toothed belts, seals, foam boards (XPS), fibers and filaments for additive manufacturing processes.

Suitable injection molding machines may be hydraulic or electromechanical and may comprise multi-component injection molding and in-mold processes. Molded parts produced by injection molding are, for example, bottles, containers, screw-top vessels, crates, barrels, buckets, pallets, technical parts for cars and transport such as bumpers, trim parts, handles, headlight covers, fittings and functional parts, electrical and electronic applications such as housing parts and accessories for televisions, computers, mobile phones, washing machines, dishwashers, coffee machines, drills, plug connections, storage media, household, leisure and sporting articles such as planters, clothes hangers, toy figures, model making parts, components for furniture such as brackets.

Parts produced by blow molding are in particular hollow bodies such as bottles, fuel tanks, canisters, washing water tanks and expansion tanks.

Parts produced by rotational molding are in particular tanks such as fuel oil tanks, and rainwater tanks, housings for machines, transport containers, leisure and water sports articles, such as kayaks.

Calendering is used in particular to produce films such as decorative films, wallpapers and floor coverings.

Additive manufacturing processes include, for example, binder jetting (BJ), laser sintering (LS), selective laser melting (SLM), electron beam melting (EBM), fused deposition modeling (FDM), fused filament fabrication (FFF), multi-jet modeling (MJM), poly-jet modeling (PJM), layer laminated manufacturing (LLM), thermal transfer sintering (TIS), digital light processing (DLP), photopolymer jetting (PJ) and stereolithography (SL).

Exemplary molded parts that can be produced from the composition according to the invention are foils or films, foams, fibers, cables and tubes, profiles, hollow bodies, tapes, membranes, such as geomembranes, or adhesives, which are produced by extrusion, injection molding, blow molding, calendering, pressing processes, spinning processes, rotomolding, e.g. for packaging, e.g. for food, detergents, cosmetics, adhesives in the form of films, bottles, bags, screw-top cans, storage and transport containers such as boxes, crates, barrels, buckets, pallets Automotive, railroad, aircraft, ship and machine parts such as construction applications such as profiles, construction foils, cable ducts, house cladding, noise barriers, drainage channels, profiled boards, floor coverings, roads and landscaping applications such as beacon bases, posts, barriers, geotextiles, electrical and electronic applications such as housing parts and accessories for televisions, computers, cell phones, washing machines, dishwashers, coffee machines, drills, connectors, storage media, cable insulation, pipes for e.g. water, gas, waste water, irrigation; drainage pipes, hygiene articles such as diapers, furniture and textile applications such as curtains and upholstery, worktops, household, leisure and sports articles such as balls, tennis rackets, skis, flower pots, rain barrels, clothes hangers, agricultural applications such as mulch, tunnel or perforated films, plant pots, pharmaceutical and plant protection applications such as the encapsulation of active ingredients and biologically active substances, in medical technology for the production of suture material, dressing material, orthoses and prostheses.

The invention further relates to a method for stabilizing a plastic composition, in particular against oxidative, thermal and/or actinic degradation, in which at least one polymer according to general formula I as defined above is incorporated into at least one plastic or a blend of at least two plastics.

Another aspect of the present invention relates to a stabilizer composition consisting of
a) at least one polymer according to general formula I as defined above (component A), and
b) at least one additive (component B)) selected from the group consisting of primary antioxidants, secondary antioxidants, UV absorbers, light stabilizers, in particular the hindered amines as light (HALS) and long-term heat stabilizers (HAS), metal deactivators, filler deactivators, antiozonants, nucleating agents, antinucleating agents, transparency improvers (clarifiers), impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde and formaldehyde scavengers, blowing agents, degradation additives (prodegradants), defoaming agents, odor scavengers, odor-improving substances, PVC heat stabilizers, marking agents, antifogging agents, gloss improvers, mattifying agents, additives for increasing the electrical and/or thermal conductivity, repellents, fillers and reinforcing agents and mixtures hereof.

In the stabilizer composition it is preferred if component A and component B are present in a weight ratio of 100:1 to 1:100, preferably 10:1 to 1:10, particularly preferably from 5:1 to 1:5.

The present invention is explained in more detail with reference to the following embodiments, without limiting the invention to the specific embodiments presented.

### Exemplary Embodiments

To test the effect of the stabilizers according to the invention, a commercially available polypropylene (Moplen HP 500N, Lyondell Basell Industries) was homogenized in a powder-powder mixture with the stabilizers according to the invention and circulated in a twin-screw microextruder (MC 5, manufacturer DSM) for 30 minutes at 200° C. and 90 rpm and the decrease in force was recorded. The force is a direct measure of the molecular weight of polypropylene: the lower the decrease, the higher the stabilizing effect.

The addition of 0.2 to 0.5% of a polyvinyl ester produced from a commercially available polyvinyl alcohol (according to supplier Sigma-Aldrich, M_{w}=13000-23000, degree of hydrolysis 87-89%, i.e. containing 11-13% polyvinyl acetate groups), with polyvinyl ester produced from methyl vanillate by transesterification, containing 50% vanillic acid vinyl ester, leads to increased processing stabilization, i.e. to a higher residual strength, compared to a polypropylene without addition. A further improvement in processing stability is achieved by adding 0.25% mannitol or 0.25% tris-(2,4-di-tertbutylphenyl)phosphite to 0.25% of the vinyl ester.

1-20. (canceled)

21. A polymer containing a repeating unit (A) of general formula I 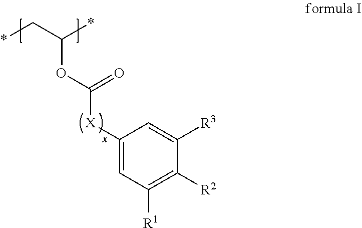
wherein
R¹, R² and R³ are each independently selected from the group consisting of hydroxy, linear or branched alkoxy groups having 1 to 6 carbon atoms and hydrogen, with the proviso that at least one of the groups R¹, R² and R³ is a hydroxy group and at least one of the groups R¹, R² and R³ is a linear or branched alkoxy group having 1 to 6 carbon atoms, wherein R¹, R² and R³ are the same or different at each occurrence,
X is selected from the group consisting of —(CH₂)_{y}— wherein y is an integer from 1 to 12, —(CH═CH)—, and —(CH═CMe)-, and
x is 0 or 1.

22. The polymer according to claim 21, wherein
R¹ is hydrogen, hydroxy, or a linear or branched alkoxy group having 1 to 6 carbon atoms,
R² is hydroxy, and
R³ is a linear or branched alkoxy group having 1 to 6 carbon atoms.

23. The polymer according to claim 21, further comprising at least one further repeating unit (B) selected from repeating units derived from monomers polymerizable by free-radical, controlled free-radical, or coordinative polymerization.

24. The polymer according to claim 23, wherein the at least one further repeating unit (B) is selected from the following repeating units: 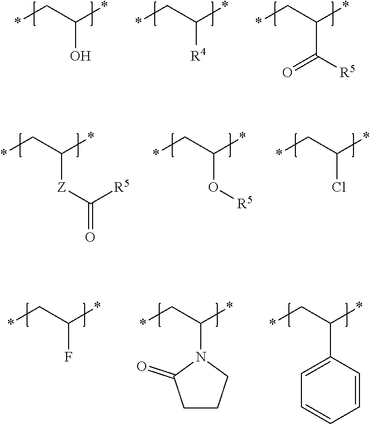
wherein
R⁴ is selected from the group consisting of hydrogen and linear or branched alkyl radicals having 1 to 36 carbon atoms,
R⁵ is selected from the group consisting of linear or branched alkyl radicals having 1 to 36 carbon atoms, and
Z is O or NH.

25. The polymer according to claim 23, wherein the molar ratio of the repeating unit (A) to the total of all repeating units is 0.01 to <1.0.

26. The polymer according to claim 21, whose weight-average molecular weight is 10³ to 10⁶ g/mol.

27. The polymer according to claim 21, which contains the repeating unit (A) according to general formula I and the following repeating units (B1) and (B2): 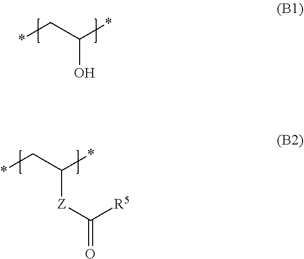
wherein Z and R⁵ have the meaning given above.

28. The polymer according to claim 27, wherein
the molar ratio of the repeating unit (A) to the total of all repeating units is 0.25 to 0.95,
the molar ratio of the repeating unit (B1) to the total of all repeating units is 0.05 to 0.50, and
the molar ratio of the repeating unit (B2) to the total of all repeating units is 0.05 to 0.25.

29. A method of stabilizing for stabilizing a plastic comprising adding to the plastic one or more polymers having a repeating unit (A) of general formula I 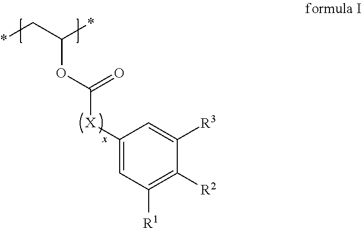
wherein
R¹, R², and R³ are each independently selected from the group consisting of hydroxy, linear or branched alkoxy groups having 1 to 6 carbon atoms and hydrogen, with the proviso that at least one of groups R¹, R² and R³ is a hydroxy group, wherein R¹, R² and R³ are the same or different at each occurrence,
X is selected from the group consisting of —(CH₂)_{y}—, wherein y is an integer from 1 to 12, —(CH═CH)— and —(CH═CMe)-, and
x is 0 or 1.

30. The method according to claim 29, wherein at least one of the groups R¹, R² and R³ is a linear or branched alkoxy group having 1 to 6 carbon atoms.

31. The method according to claim 29, wherein the polymer or mixture of polymers is present in the plastic in a proportion by weight from 0.01 to 10.00 wt. %.

32. The method according to claim 29, wherein the plastic is one or more selected from the following plastics or a combination thereof:
(a) LDPE, LLDPE, VLDPE, ULDPE, MDPE, HDPE, UHMWPE, metallocene-PE (m-PE), polypropylene, polyisobutylene, poly-4-methyl-pentene-1, polybutadiene, polyisoprene, polycyclooctene, polyalkylene-carbon monoxide copolymers, polypropylene-polyethylene copolymers, EPM, EPDM, copolymer of propylene and 5-ethylidene-2-norbornene, ethylene-vinyl acetate (EVA), ethylene-butyl acrylate, ethylene-acrylic acid and their salts (ionomers), ethylene-acrylic acid-glycidyl (meth)acrylate, polypropylene-graft-maleic anhydride, polypropylene-graft-acrylic acid, polyethylene-graft-acrylic acid, polyethylene-polybutyl acrylate-graft-maleic anhydride, blends of graft polymers with LDPE or LLDPE, and long-chain branched polypropylene copolymers produced with alpha-olefins as comonomers,
(b) polystyrene, polymethylstyrene, poly-alpha-methylstyrene, polyvinylnaphthalene, polyvinylbiphenyl, polyvinyltoluene, styrene-butadiene (SB), styrene-butadiene-styrene (SBS), styrene-ethylene-butylene-styrene (SEBS), styrene-ethylene-propylene-styrene, styrene isoprene, styrene-isoprene-styrene (SIS), styrene-butadiene-acrylonitrile (ABS), styrene-acrylonitrile (SAN), styrene-acrylonitrile-acrylate (ASA), styrene-ethylene, styrene-maleic anhydride copolymers, graft copolymers of methyl methacrylate, styrene butadiene and ABS (MABS), and hydrogenated polystyrene,
(c) polyvinyl chloride (PVC), polychloroprene, polyvinylidene chloride (PVDC), copolymers of vinyl chloride and vinylidene chloride or of vinyl chloride and vinyl acetate, chlorinated polyethylene, polyvinylidene fluoride, and epichlorohydrin—homo and copolymers,
(d) polymethyl methacrylate (PMMA), polybutyl acrylate, polylauryl acrylate; polystearyl acrylate; polyglycidyl acrylate, polyglycidyl methacrylate, polyacrylonitrile, polyacrylamides, and polyacrylonitrile-polyalkyl acrylate,
(e) polyvinyl alcohol, polyvinyl acetate, polyvinyl butyral, and polyallyl phthalate, and polyallyl melamine,
(f) polyoxymethylene (POM) and copolymers thereof,
(g) polyphenylene oxides and blends with polystyrene or polyamides,
(h) polyethylene glycol, polypropylene glycol, polyethylene oxide, polypropylene oxide, and polytetrahydrofuran,
(i) polyurethanes and polyureas,
(j) polyamide-6, 6.6, 6.10, 4.6, 4.10, 6.12, 10.10, 10.12, 12.12, polyamide 11, polyamide 12, aromatic polyamides, blends of different polyamides, and blends of polyamides and polyolefins,
(k) polyimides, polyamideimides, polyetherimides, polyesterimides, poly(ether)ketones, polysulfones, polyethersulfones, polyarylsulfones, polyphenylene sulfides, polybenzimidazoles, and polyhydantoins,
(l) polyethylene terephthalate (PET), polybutylene terephthalate (PBT), polypropylene terephthalate (PTI), polyethylene naphthylate (PEN), poly-1,4-dimethylolcyclohexane terephthalate, polyhydroxybenzoate, polyhydroxynaphthalate, polylactic acid (PLA), polyhydroxybutyrate (PHB), polyhydroxyvalerate (PHV), polyethylene succinate, polytetramethylene succinate, and polycaprolactone,
(m) polycarbonates, polyester carbonates, and PC/ABS, PC/PBT, PC/PET/PBT, and PC/PA blends,
(n) cellulose nitrate, cellulose acetate, cellulose propionate, cellulose butyrate, and blends thereof,
(o) epoxy resins consisting of di- or polyfunctional epoxy compounds in combination with hardeners based on amines, anhydrides, dicyandiamide, mercaptans, isocyanates, and catalytically acting hardeners,
(p) phenol-formaldehyde resins, urea-formaldehyde resins, and melamine-formaldehyde resins,
(q) unsaturated polyester resins prepared from unsaturated dicarboxylic acids and diols with vinyl compounds,
(r) dimethylsiloxane, methyl-phenyl-siloxane, diphenylsiloxane, and vinyl-group-terminated siloxanes, and
(s) mixtures, combinations or blends of two or more of the aforementioned polymers.

33. The method according to claim 29, comprising a further additive selected from the group consisting of primary antioxidants, secondary antioxidants, UV absorbers, light stabilizers, metal deactivators, filler deactivators, antiozonants, nucleating agents, antinucleating agents, transparency improvers, transparency clarifiers, impact modifiers, plasticizers, lubricants, rheology modifiers, viscosity modifiers, thixotropic agents, chain extenders, processing aids, demoulding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde and formaldehyde scavengers, blowing agents, degradation additives, defoaming agents, odour scavengers, odour-improving substances, PVC heat stabilizers, marking agents, antifogging agents, gloss improvers, mattifying agents, additives for increasing the electrical and/or thermal conductivity, repellents, fillers, reinforcing agents, and mixtures thereof.

34. The method according to claim 33, wherein the at least one further additive is contained or is added in an amount from 0.01 to 80 wt. % in relation to the total of the at least one polymer according to general formula I, the plastic, and the at least one additive.

35. A plastic composition comprising at least one plastic and at least one polymer of formula (A) according to claim 21.

36. The plastic composition according to claim 35, having the following composition: 0.01 to 10.00 wt. % of the at least one polymer of formula (A), 99.99 to 10.00 wt. % of at least one plastic, and 0 to 80.00 wt. % of at least one additive, wherein the constituents of the plastic composition add up to 100 wt. %.

37. The plastic composition according to claim 36, wherein the at least one additive is selected from the group consisting of primary antioxidants, secondary antioxidants, UV absorbers, light stabilizers, metal deactivators, filler deactivators, antiozonants, nucleating agents, antinucleating agents, transparency improvers, transparency clarifiers, impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde and formaldehyde scavengers, blowing agents, degradation additives or prodegradants, defoaming agents, odour scavengers, odor-improving substances, PVC heat stabilizers, marking agents, antifogging agents, gloss improvers, mattifying agents, additives for increasing the electrical and/or thermal conductivity, repellents, fillers, and reinforcing agents.

38. A stabilizer composition consisting of
a) Component A, which is at least one polymer as defined in claim 21, and
b) Component B, which is at least one additive selected from the group consisting of primary antioxidants, secondary antioxidants, UV absorbers, light stabilizers, metal deactivators, filler deactivators, antiozonants, nucleating agents, antinucleating agents, transparency improvers, transparency clarifiers, impact modifiers, plasticizers, lubricants, rheology or viscosity modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, surface modifiers, hydrolysis stabilizers, adhesion promoters, dispersing agents, compatibilizers, oxygen scavengers, acid scavengers, acetaldehyde scavengers, formaldehyde scavengers, blowing agents, degradation additives, defoaming agents, odour scavengers, odor-improving substances, PVC heat stabilizers, marking agents, antifogging agents, gloss improvers, mattifying agents, additives for increasing the electrical and/or thermal conductivity, repellents, fillers, and reinforcing agents.

39. The stabilizer composition according to claim 38, wherein component A and component B are present in a weight ratio of 100:1 to 1:100.
